(19) United States
(12) Patent Application Publication
(10) Pub. No.: US 2026/0362182 A1
(43) Pub. Date: Nov. 12, 2026

(54) PERFORMANCE MONITORING FOR MEASUREMENT EVENT PREDICTION

(71) Applicant: QUALCOMM Incorporated, San Diego, CA (US)

(72) Inventors: Punyaslok PURKAYASTHA, San Diego, CA (US); Aziz GHOLMIEH, Del Mar, CA (US); Rajeev KUMAR, San Diego, CA (US); Hamed PEZESHKI, San Diego, CA (US)

(21) Appl. No.: 19/549,769

(22) Filed: Feb. 25, 2026

Related U.S. Application Data
(60) Provisional application No. 63/802,119, filed on May 8, 2025.

(51) Int. Cl. H04W 24/08; H04B 17/391; H04L 41/5009; H04W 36/00

(52) U.S. Cl. CPC H04W 24/08; H04B 17/3913; H04L 41/5009; H04W 36/0016; H04W 36/0058

(57) ABSTRACT

Various aspects of the present disclosure generally relate to wireless communication. In some aspects, a user equipment (UE) may wirelessly receive, from a network node, a performance monitoring configuration. The UE may obtain, using a predictive model, one or more predicted measurement events associated with one or more of a serving cell or a neighbor cell. The UE may wirelessly transmit, to the network node, one or more reports that includes one or more key performance indicators (KPIs) associated with the one or more predicted measurement events in accordance with the performance monitoring configuration. Numerous other aspects are described.

### CROSS-REFERENCE TO RELATED APPLICATION

This Patent Application claims priority to U.S. Provisional Patent Application No. 63/802,119, filed on May 8, 2025, entitled “PERFORMANCE MONITORING FOR MEASUREMENT EVENT PREDICTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with performance monitoring for measurement event prediction.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless networks, an artificial intelligence or machine learning (AI/ML) model may be deployed at or on one or more wireless nodes (e.g., a user equipment (UE) and/or a network node) for use in generating one or more UE-side predictions that may be indicated in a prediction report sent to a network node and/or one or more network-side predictions that may be indicated in a prediction results indication sent to a UE. For example, principles or algorithms for intelligence enabled by AI/ML technologies have been utilized and/or studied for various possible use cases, including beam management, energy saving, load balancing, coverage optimization, and/or mobility management. For example, in some cases, AI/ML techniques have been used for downlink beam prediction, where measurement results associated with a first set of beams are used to predict measurements for a second set of beams to enable spatial beam prediction (e.g., where the predicted measurements are for different spatial directions than the measurement results for the first set of beams) or temporal beam prediction (e.g., where the predicted measurements are for a future time window or future time instances). In some cases, the predicted measurements can be used to predict certain measurement events, such as a mobility event that triggers a handover.

### SUMMARY

The systems, methods, and devices of this disclosure each have several innovative aspects, no single one of which is solely responsible for the desirable attributes disclosed herein.

Some aspects described herein relate to a user equipment (UE). The UE may include one or more antennas and a processing system that includes processor circuitry and memory circuitry that stores code. The processing system may be configured to cause the UE to wirelessly receive, from a network node, a performance monitoring configuration. The processing system may be configured to cause the UE to obtain, using a predictive model, one or more predicted measurement events associated with one or more of a serving cell or a neighbor cell. The processing system may be configured to cause the UE to wirelessly transmit, to the network node, one or more reports that includes one or more key performance indicators (KPIs) associated with the one or more predicted measurement events in accordance with the performance monitoring configuration.

Some aspects described herein relate to a network node. The network node may include one or more memories and one or more processors coupled to the one or more antennas and a processing system that includes processor circuitry and memory circuitry that stores code. The processing system may be configured to cause the network node to wirelessly transmit, to a UE, a performance monitoring configuration. The processing system may be configured to cause the network node to wirelessly receive, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell.

Some aspects described herein relate to a method of wireless communication performed by a UE. The method may include wirelessly receiving, from a network node, a performance monitoring configuration. The method may include obtaining, using a predictive model, one or more predicted measurement events associated with one or more of a serving cell or a neighbor cell. The method may include wirelessly transmitting, to the network node, one or more reports that includes one or more KPIs associated with the one or more predicted measurement events in accordance with the performance monitoring configuration.

Some aspects described herein relate to a method of wireless communication performed by a network node. The method may include wirelessly transmitting, to a UE, a performance monitoring configuration. The method may include wirelessly receiving, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell.

Some aspects described herein relate to a non-transitory computer-readable medium that stores a set of instructions for wireless communication by a UE. The set of instructions, when executed by one or more processors of the UE, may cause the UE to wirelessly receive, from a network node, a performance monitoring configuration. The set of instructions, when executed by one or more processors of the UE, may cause the UE to obtain, using a predictive model, one or more predicted measurement events associated with one or more of a serving cell or a neighbor cell. The set of instructions, when executed by one or more processors of the UE, may cause the UE to wirelessly transmit, to the network node, one or more reports that includes one or more KPIs associated with the one or more predicted measurement events in accordance with the performance monitoring configuration.

Some aspects described herein relate to a non-transitory computer-readable medium that stores a set of instructions for wireless communication by a network node. The set of instructions, when executed by one or more processors of the network node, may cause the network node to wirelessly transmit, to a UE, a performance monitoring configuration. The set of instructions, when executed by one or more processors of the network node, may cause the network node to wirelessly receive, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell.

Some aspects described herein relate to an apparatus for wireless communication. The apparatus may include means for wirelessly receiving, from a network node, a performance monitoring configuration. The apparatus may include means for obtaining, using a predictive model, one or more predicted measurement events associated with one or more of a serving cell or a neighbor cell. The apparatus may include means for wirelessly transmitting, to the network node, one or more reports that includes one or more KPIs associated with the one or more predicted measurement events in accordance with the performance monitoring configuration.

Some aspects described herein relate to an apparatus for wireless communication. The apparatus may include means for wirelessly transmitting, to a UE, a performance monitoring configuration. The apparatus may include means for wirelessly receiving, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a wireless communication network.

FIG. 2 illustrates an example of a make-before-break handover procedure

FIG. 3 illustrates an example of a conditional handover procedure.

FIG. 4 illustrates an example of a Layer 1 or Layer 2 triggered mobility procedure.

FIG. 5 illustrates an example architecture of a functional framework for radio access network (RAN) intelligence enabled by data collection.

FIG. 6 illustrates an example of artificial intelligence and/or machine learning based beam management.

FIGS. 7A-7B illustrate examples associated with performance monitoring for measurement event prediction.

FIG. 8 illustrates an example process performed, for example, at a user equipment (UE) or an apparatus of a UE.

FIG. 9 illustrates an example process performed, for example, at a network node or an apparatus of a network node.

FIG. 10 illustrates an example apparatus for wireless communication.

FIG. 11 illustrates an example apparatus for wireless communication.

### DETAILED DESCRIPTION

In wireless communication systems, handover procedures serve an important role in ensuring seamless connectivity when a wireless link between a user equipment (UE) and a serving cell becomes degraded and/or a wireless link to a neighbor cell improves or becomes better than the serving cell. For example, a UE may be configured to obtain measurements for one or more parameters that relate to channel quality associated with the serving cell and one or more neighbor cells and to provide the measurements to the serving cell. The serving cell then determines whether a handover to a target (neighbor) cell may be needed based on the measurements provided by the UE. In cases where the serving cell determines that a handover to a target cell is needed, the serving cell communicates with the target cell to prepare for the handover, sends a handover command to the UE to instruct the UE to disconnect from the serving cell and connect to the target cell, and releases network resources allocated to the UE when the handover is successful and the connection to the target cell is confirmed.

Traditional handover approaches use measurement reports that the UE transmits to a network node when one or more measurement events occur. For example, various measurement events, such as measurement events A1 through A6 for intra-radio access technology (RAT) handovers, are triggered when a serving cell measurement and/or a neighbor cell measurement satisfy one or more conditions that are typically defined according to one or more thresholds. For example, measurement event A3 is triggered when a measurement associated with a neighbor cell exceeds a measurement associated with a current serving cell by an offset (e.g., a difference between the neighbor cell and serving cell measurements satisfy a threshold), indicating that the UE should connect to the neighbor cell. Similarly, measurement event A5 is triggered when the measurement associated with special cell (e.g., a primary cell (PCell) or a primary secondary cell (PSCell)) fails to satisfy a first threshold and a measurement associated with the neighbor cell satisfies a second threshold. Accurate detection of measurement events and timely reporting when measurement events are detected are important to maintaining reliable connectivity and minimizing service interruptions. However, handover procedures that are triggered according to real-time measurements are reactive in nature, which may result in handover failures or handover delays (e.g., because a measurement report transmitted by the UE may not reach the serving cell when the signal quality has significantly degraded). Reactive handover procedures may lead to suboptimal decisions, such as delayed transitions, dropped connections, or unnecessary handovers, which degrade network performance and user experience.

Accordingly, in some wireless networks, one or more artificial intelligence and/or machine learning (AI/ML) models may be used to enable measurement event prediction for direct and/or indirect measurement event prediction. For example, in a direct measurement event prediction use case, a UE obtains actual serving cell and/or neighbor cell measurements, and uses a predictive model to predict a future measurement event according to the actual serving cell and/or neighbor cell measurements. Additionally, or alternatively, in an indirect measurement event prediction use case, the UE may use the predictive model to predict future measurements associated with the serving cell and/or the neighbor cell, and predicted measurements may be used alone or in combination with historical measurements to predict whether a measurement event will occur in a future time window or time instant. However, in cases where a UE-side predictive model is used to predict future measurement events, an important issue is to monitor performance of the predictive model to ensure that the predictions or inferences made by the predictive model are accurate and reliable, to enable adaptation to changes in an environment and/or data patterns to optimize computational and network resources and ensure that the predictive model does not introduce unnecessary overhead or inefficiencies (e.g., when the predictive model is performing poorly), to ensure that predicted outcomes closely align with actual measurements and/or measurement events, and/or to otherwise obtain other insights that are important for lifecycle management (LCM) decisions, such as when to update, retrain, reconfigure, or retire the predictive model.

However, performance monitoring for AI/ML models that are used in wireless networks, such as predictive models for predicting measurement events, poses various challenges due to the need for coordination between the UE and the network. For example, a UE may operate in different performance monitoring modes, such as an active performance monitoring mode (e.g., where reports are transmitted for every predicted measurement event occurrence) or inactive monitoring (e.g., where reports are transmitted after storing statistics over a configured observation window). Additionally, or alternatively, the UE may switch between direct measurement event prediction (e.g., where actual measurements are used to predict future measurement events) and indirect event prediction (e.g., where predicted measurements are used alone or in combination with historical measurements to predict future measurement events). The variations among different performance monitoring modes or configurations may have various tradeoffs, such that a network node may adapt performance monitoring configurations and signaling mechanisms to support effective and efficient performance monitoring. For example, a network node may adapt a performance monitoring configuration for a model used to predict future measurement events to ensure that predicted measurement event times closely align with actual measurement event times and that handover attempts triggered by predicted measurement events are successful, to manage tradeoffs between frequent reporting that increases signaling overhead and periodic reporting that delay corrective actions, to address scenarios where a UE may not have access to ground truth information about whether or when an actual measurement event occurred due to early initiation of a handover, and/or to support dynamic performance monitoring modes in accordance with UE capabilities, network requirements, and/or operational conditions, among other examples. Addressing these challenges is important to enable reliable and efficient performance monitoring of predictive models used to predict future measurement events in a wireless communication system.

Various aspects relate generally to performance monitoring for predictive measurement events in a wireless communication system. Some aspects more specifically relate to a UE receiving a performance monitoring configuration from a network node, obtaining predicted measurement events associated with one or more serving cells and/or neighbor cells using a predictive model, and transmitting performance monitoring reports that include key performance indicators (KPIs) associated with the predicted measurement events to the network node in accordance with the performance monitoring configuration. For example, the KPIs that are indicated in a performance monitoring report may include information such as handover success rates, handover failure rates, counters for true (or correct), false (or incorrect), missed, and/or null measurement event prediction, and/or statistical metrics (e.g., a precision score, a recall score, an F1 score, or the like) that reflect the accuracy and/or reliability of the predictive model used for measurement event prediction.

In some aspects, the performance monitoring configuration provided by the network node may indicate various performance monitoring parameters, including the measurement events to monitor (e.g., A1 through A6 measurement events, or any subset or combination of measurement events), whether predicted measurement events are based on actual measurements, predicted measurements, or both, the content to include in the performance monitoring reports, and/or thresholds or periodicities for triggering performance monitoring report transmissions. In some aspects, the performance monitoring configuration may include parameters for evaluating predicted measurement events, such as an event time difference (ETD) parameter for evaluating a temporal alignment between predicted measurement events and actual measurement events (that occur), configurations for predicting measurement events (e.g., threshold values, time-to-trigger (TTT) parameters, hysteresis parameters, or the like), and/or an indication of whether to transmit ground truth information for predicted measurement events.

Particular aspects of the subject matter described in this disclosure can be implemented to realize one or more of the following advantages. In some examples, by enabling the UE to transmit KPIs and performance monitoring reports, the described techniques provide important insights into the effectiveness and accuracy of predictive measurement events that are used in handover scenarios. In some examples, the insights obtained through the performance monitoring reports allow the network to make informed decisions about LCM for predictive models, optimizing configurations or deactivating predictive models when appropriate, thereby improving the accuracy of measurement events that are relied upon to make handover decisions and reducing resource consumption or signaling overhead caused by unreliable measurement event predictions. For example, by monitoring metrics such as handover success rates and ETD alignment, some aspects may be used to disable or reconfigure measurement event prediction to reduce unnecessary signaling and/or processing caused by inaccurate predictions and/or poorly timed handovers, and/or to disable legacy measurement reporting based on actual measurements and measurement events when predicted measurement events are accurate and/or result in a high handover success rate or low handover failure rate. Furthermore, periodic reporting and event-triggered reporting mechanisms may be supported to conserve signaling and network resources while maintaining meaningful performance monitoring data collection. For example, periodic performance monitoring reports allow the UE to accumulate statistics over longer durations, enabling a broader evaluation of predictive model performance across multiple handovers while avoiding excessive signaling overhead, while event-triggered reports provide immediate feedback on individual predicted events, allowing the network to respond dynamically to performance issues. Additionally, in some aspects, prohibit timers may prevent frequent performance monitoring reporting, which conserves network bandwidth, processing resources, and/or power.

In addition, in scenarios where a UE lacks ground truth information due to early handover initiation, the ability to transmit performance monitoring reports to the target cell (or include the performance monitoring report in a suitable message) ensures continuity in performance monitoring and provides a mechanism for validating handover decisions post-execution. In this way, the network may reduce computational overhead associated with recalibrating predictive models in accordance with incomplete and/or inaccurate data. Furthermore, using logical model identifiers and/or functionality identifiers in performance monitoring reports enables the network node to track the performance for specific AI/ML models across multiple cells and UEs, facilitating crowd-sourced evaluations for improved resource allocation and mobility management. By integrating adaptive monitoring modes (e.g., active and inactive) and LCM operations into the performance monitoring framework, the techniques described herein may improve overall system efficiency by reducing dropped connections, optimizing model configurations, and conserving processing, memory, and/or network resources. Additionally, network-side monitoring capabilities may complement UE-side or UE-assisted monitoring, enabling networks to maintain control over performance evaluation and model adjustments, even in scenarios with constrained UE capabilities. In this way, the described techniques may enhance the accuracy and efficiency of predictive measurement event models while minimizing resource consumption across the system.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or AI/ML, among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

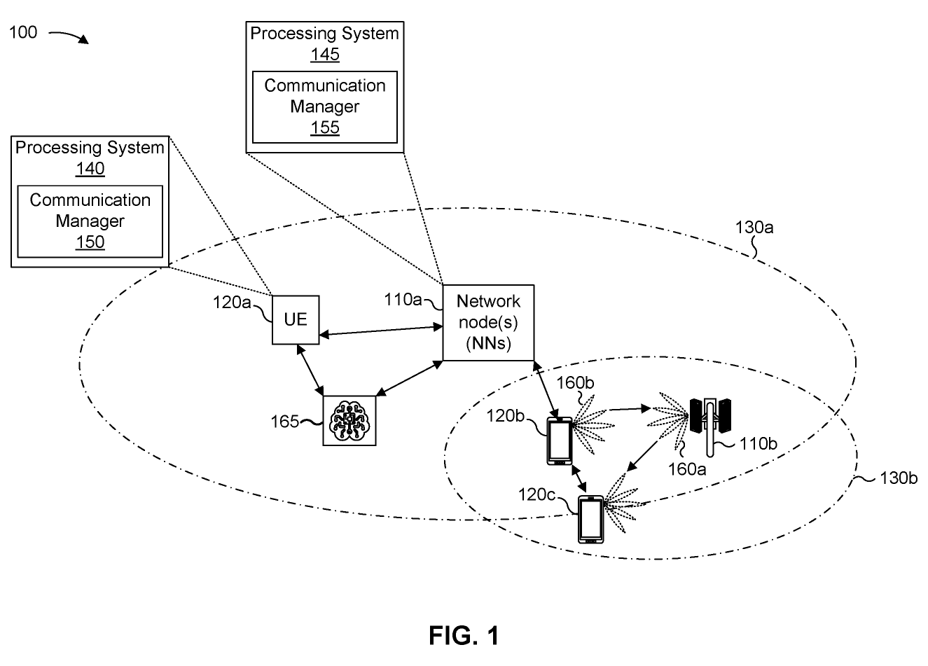

FIG. 1 illustrates an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may wirelessly receive, from a network node 110, a performance monitoring configuration; obtain, using a predictive model, one or more predicted measurement events associated with one or more of a serving cell or a neighbor cell; and wirelessly transmit, to the network node 110, one or more reports that includes one or more KPIs associated with the one or more predicted measurement events in accordance with the performance monitoring configuration. Additionally, or alternatively, the communication manager 150 may perform one or more other operations described herein.

In some aspects, the network node 110 may include a communication manager 155. As described in more detail elsewhere herein, the communication manager 155 may wirelessly transmit, to a UE 120, a performance monitoring configuration; and wirelessly receive, from the UE 120 in accordance with the performance monitoring configuration, one or more reports that includes one or more KPIs associated with one or more predicted measurement events associated with a predictive model, wherein the one or more predicted measurement events are associated with one or more of a serving cell or a neighbor cell. Additionally, or alternatively, the communication manager 155 may perform one or more other operations described herein.

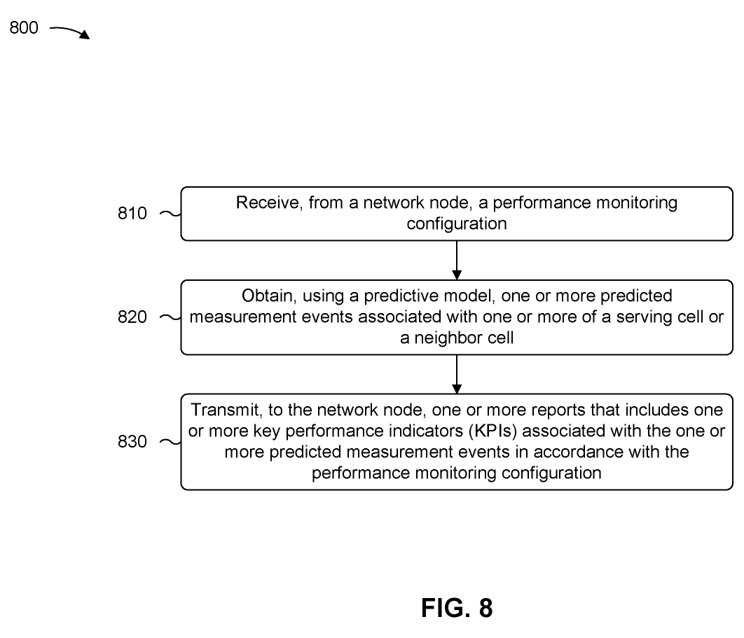

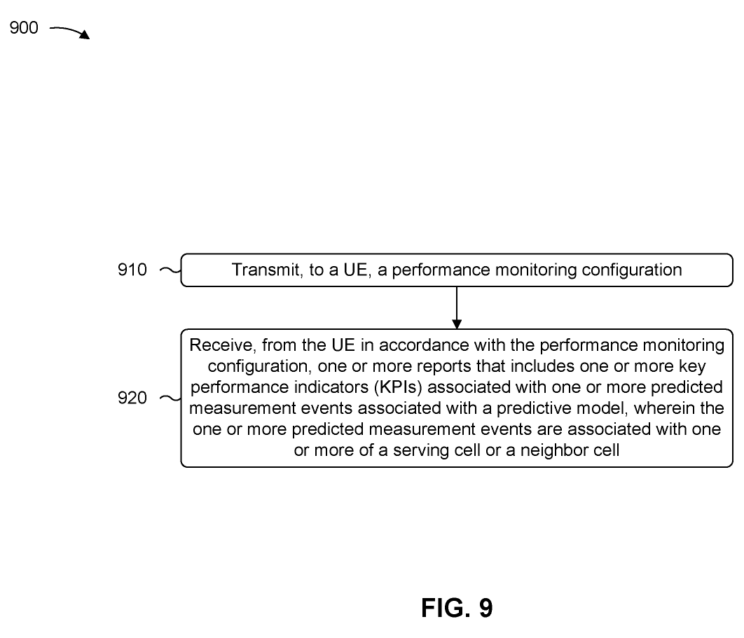

The network node 110, the processing system 145 of the network node 110, the UE 120, the processing system 140 of the UE 120, or any other component(s) of FIG. 1 may implement one or more techniques or perform one or more operations associated with performance monitoring for measurement event prediction, as described in more detail elsewhere herein. For example, the processing system 145 of the network node 110, or the processing system 140 of the UE 120 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

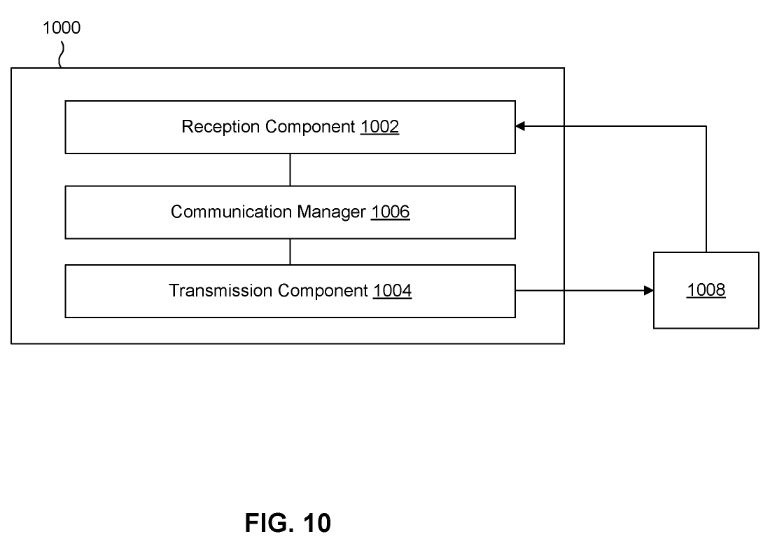

In some aspects, the UE 120 includes means for wirelessly receiving, from a network node 110, a performance monitoring configuration; means for obtaining, using a predictive model, one or more predicted measurement events associated with one or more of a serving cell or a neighbor cell; or means for wirelessly transmitting, to the network node 110, one or more reports that includes one or more KPIs associated with the one or more predicted measurement events in accordance with the performance monitoring configuration. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

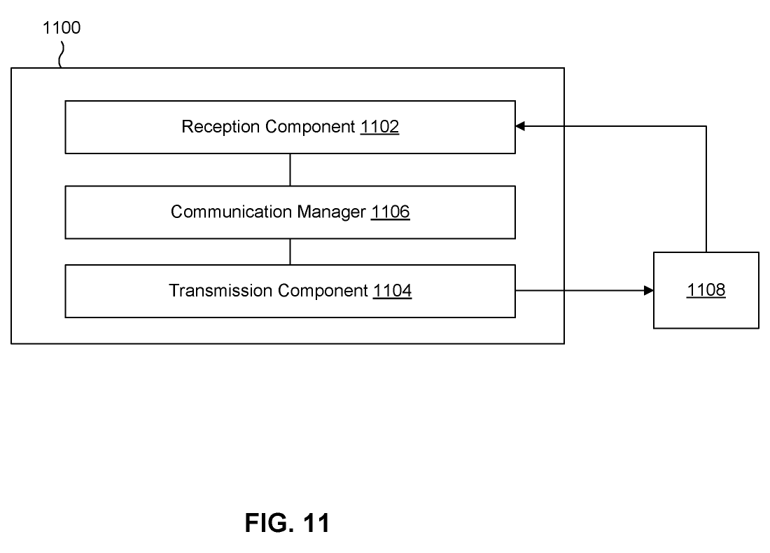

In some aspects, the network node 110 includes means for wirelessly transmitting, to a UE 120, a performance monitoring configuration; or means for wirelessly receiving, from the UE 120 in accordance with the performance monitoring configuration, one or more reports that includes one or more KPIs associated with one or more predicted measurement events associated with a predictive model, wherein the one or more predicted measurement events are associated with one or more of a serving cell or a neighbor cell. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

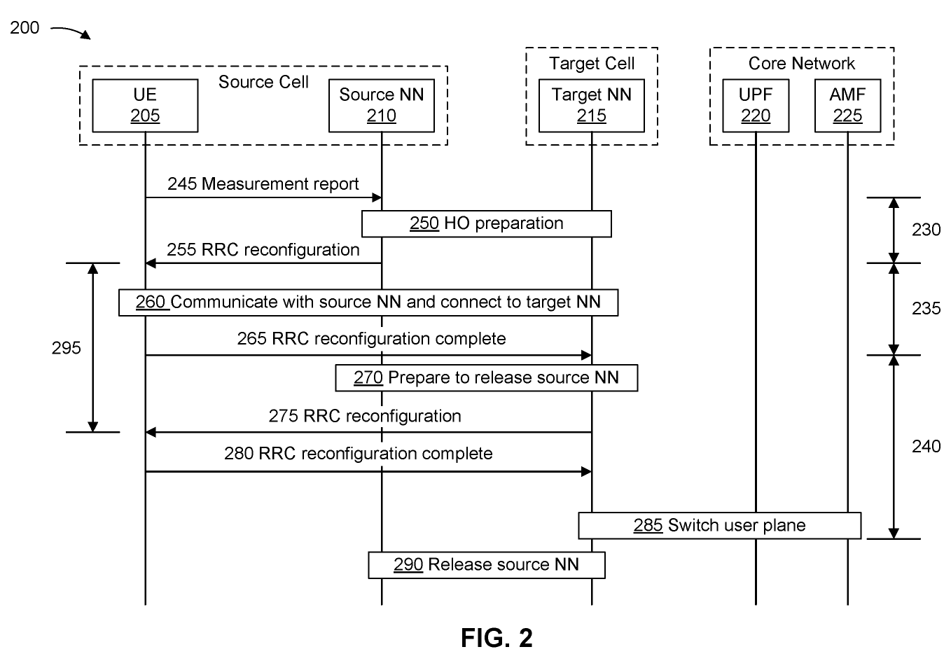

FIG. 2 illustrates an example 200 of a make-before-break (MBB) handover procedure.

As shown in FIG. 2, the MBB handover procedure may involve a UE 205, a source network node 210, a target network node 215, a user plane function (UPF) device 220, and an access and mobility management function (AMF) device 225. In some examples, actions described as being performed by a network node may be performed by multiple network nodes. For example, configuration actions and/or core network communication actions may be performed by a first network node (e.g., a CU or a DU), and radio communication actions may be performed by a second network node (e.g., a DU or an RU). The UE 205 may correspond to the UE 120 described elsewhere herein. The source network node 210 and/or the target network node 215 may correspond to the network node 110 described elsewhere herein. The UE 205 and the source network node 210 may be connected (e.g., may have an RRC connection) via a serving cell or a source cell, and the UE 205 may undergo a handover to the target network node 215 via a target cell. The UPF device 220 and/or the AMF device 225 may be located within a core network. The source network node 210 and the target network node 215 may be in communication with the core network for mobility support and user plane functions.

As shown in FIG. 2, the MBB handover procedure may include a handover preparation phase 230, a handover execution phase 235, and a handover completion phase 240. During the handover preparation phase 230, the UE 205 may report measurements that cause the source network node 210 and/or the target network node 215 to prepare for handover and trigger execution of the handover. During the handover execution phase 235, the UE 205 may execute the handover by performing a random access procedure with the target network node 215 and establishing an RRC connection with the target network node 215. During the handover completion phase 240, the source network node 210 may forward one or more stored communications associated with the UE 205 to the target network node 215, and the UE 205 may be released from a connection with the source network node 210.

As shown by reference number 245, during the handover preparation phase 230, the UE 205 may perform one or more measurements, and may transmit a measurement report to the source network node 210 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 210 may use the measurement report to determine whether to trigger a handover to the target network node 215. For example, if one or more measurements satisfy a condition, the source network node 210 may trigger a handover of the UE 205 to the target network node 215.

As shown by reference number 250, during the handover preparation phase 230, the source network node 210 and the target network node 215 may communicate with one another to prepare for a handover of the UE 205. As part of the handover preparation, the source network node 210 may transmit a handover request to the target network node 215 to instruct the target network node 215 to prepare for the handover. The source network node 210 may communicate RRC context information associated with the UE 205 and/or configuration information associated with the UE 205 to the target network node 215. The target network node 215 may prepare for the handover by reserving resources for the UE 205. After reserving the resources, the target network node 215 may transmit an ACK to the source network node 210 in response to the handover request.

As shown by reference number 255, during the handover preparation phase 230, the source network node 210 may transmit an RRC reconfiguration message to the UE 205. The RRC reconfiguration message may include a handover command instructing the UE 205 to execute a handover procedure from the source network node 210 to the target network node 215. The handover command may include information associated with the target network node 215, such as a random access channel (RACH) preamble assignment for accessing the target network node 215. Reception of the RRC reconfiguration message, including the handover command, by the UE 205 may trigger the start of the handover execution phase 235.

As shown by reference number 260, during the handover execution phase 235, the UE 205 may execute the handover by performing a random access procedure with the target network node 215 (e.g., including synchronization with the target network node 215) while continuing to communicate with the source network node 210. For example, while the UE 205 is performing the random access procedure with the target network node 215, the UE 205 may transmit uplink data, uplink control information, and/or an uplink reference signal (e.g., an SRS) to the source network node 210, and/or may receive downlink data, DCI, and/or a downlink reference signal from the source network node 210.

As shown by reference number 265, upon successfully establishing a connection with the target network node 215 (e.g., via a random access procedure) during the handover execution phase 235, the UE 205 may transmit an RRC reconfiguration completion message to the target network node 215. Reception of the RRC reconfiguration message by the target network node 215 may trigger the start of the handover completion phase 240.

As shown by reference number 270, during the handover completion phase 240, the source network node 210 and the target network node 215 may communicate with one another to prepare for release of the connection between the source network node 210 and the UE 205. In some aspects, the target network node 215 may determine that a connection between the source network node 210 and the UE 205 is to be released, such as after receiving the RRC reconfiguration message from the UE 205. In this case, the target network node 215 may transmit a handover connection setup completion message to the source network node 210. The handover connection setup completion message may cause the source network node 210 to stop transmitting data to the UE 205 and/or to stop receiving data from the UE 205. Additionally, or alternatively, the handover connection setup completion message may cause the source network node 210 to forward communications associated with the UE 205 to the target network node 215 and/or to notify the target network node 215 of a status of one or more communications with the UE 205. For example, the source network node 210 may forward, to the target network node 215, buffered downlink communications (e.g., downlink data) for the UE 205 and/or uplink communications (e.g., uplink data) received from the UE 205. Additionally, or alternatively, the source network node 210 may notify the target network node 215 regarding a PDCP status associated with the UE 205 and/or a sequence number to be used for a downlink communication with the UE 205.

As shown by reference number 275, during the handover completion phase 240, the target network node 215 may transmit an RRC reconfiguration message to the UE 205 to instruct the UE 205 to release the connection with the source network node 210. Upon receiving the instruction to release the connection with the source network node 210, the UE 205 may stop communicating with the source network node 210. For example, the UE 205 may refrain from transmitting uplink communications to the source network node 210 and/or may refrain from monitoring for downlink communications from the source network node 210.

As shown by reference number 280, during the handover completion phase 240, the UE may transmit an RRC reconfiguration completion message to the target network node 215 to indicate that the connection between the source network node 210 and the UE 205 is being released or has been released.

As shown by reference number 285, during the handover completion phase 240, the target network node 215, the UPF device 220, and/or the AMF device 225 may communicate to switch a user plane path of the UE 205 from the source network node 210 to the target network node 215. Prior to switching the user plane path, downlink communications for the UE 205 may be routed through the core network to the source network node 210. After the user plane path is switched, downlink communications for the UE 205 may be routed through the core network to the target network node 215. Upon completing the switch of the user plane path, the AMF device 225 may transmit an end marker message to the source network node 210 to signal completion of the user plane path switch. As shown by reference number 290, the target network node 215 and the source network node 210 may communicate to release the source network node 210.

As part of the MBB handover procedure, the UE 205 may maintain simultaneous connections with the source network node 210 and the target network node 215 during a time period 295. The time period 295 may start at the beginning of the handover execution phase 235 (e.g., upon reception by the UE 205 of a handover command from the source network node 210) when the UE 205 performs a random access procedure with the target network node 215. The time period 295 may end upon release of the connection between the UE 205 and the source network node 210 (e.g., upon reception by the UE 205 of an instruction, from the target network node 215, to release the source network node 210). By maintaining simultaneous connections with the source network node 210 and the target network node 215, the handover procedure can be performed with zero or a minimal interruption to communications, thereby reducing latency.

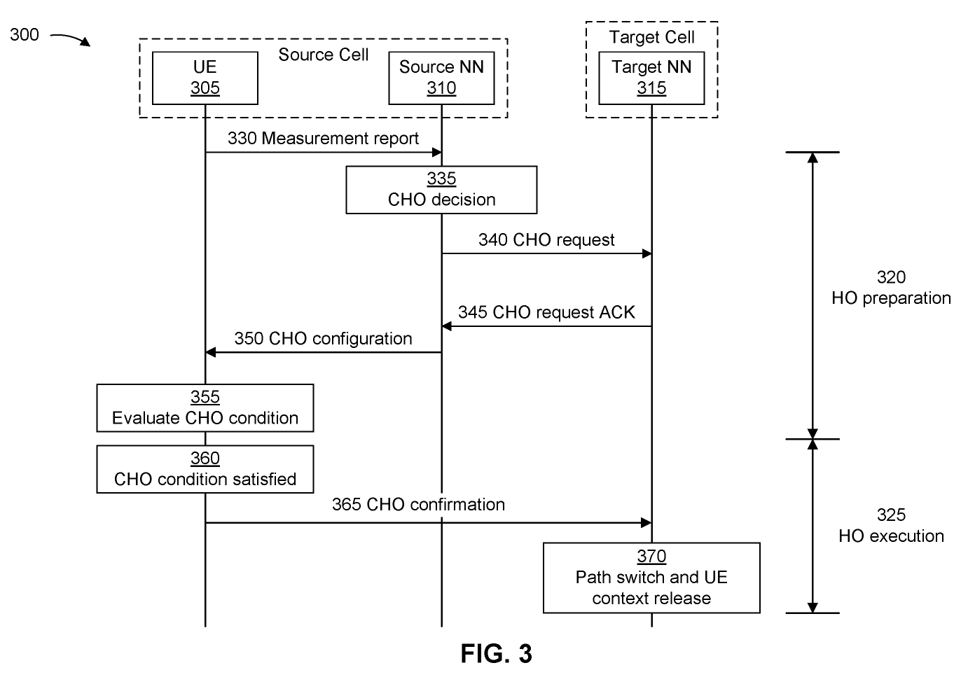

FIG. 3 illustrates an example 300 of a conditional handover procedure. As shown in FIG. 3, the conditional handover procedure may involve a UE 305, a source network node 310, and a target network node 315. In some examples, actions described as being performed by a network node may be performed by multiple network nodes. The UE 305 and the source network node 310 may be connected (e.g., may have an RRC connection) via a serving cell or a source cell, and the UE 305 may undergo a conditional handover to the target network node 315 via a target cell.

As shown in FIG. 3, the conditional handover procedure may include a handover preparation phase 320 and a handover execution phase 325. During the handover preparation phase 320, the source network node 310 may prepare one or more candidate target cells in advance, and may send a conditional handover configuration to the UE 305 when radio conditions between the UE 305 and the source network node 310 are not degraded. When the conditional handover configuration is received, the UE 305 stores a conditional handover message, and applies the stored conditional handover message only when a configured condition is satisfied for a configured candidate target cell. During the handover execution phase 325, the UE 305 may execute the handover by performing a RACH procedure with the target network node 315 and establishing an RRC connection with the target network node 315 based on a configured condition being satisfied for the target network node 315. Accordingly, as described herein, the conditional handover procedure may reduce handover failure occurrences (e.g., where a handover is not triggered because a measurement report transmitted by the UE 305 does not reach the source network node 310 and/or because a handover command transmitted by the source network node 310 does not reach the UE 305 due to degraded signal conditions between the UE 305 and the source network node 310).

For example, as shown by reference number 330, during the handover preparation phase 320, the UE 305 may transmit, and the source network node 310 may receive, a measurement report that indicates measurements related to a signal strength (e.g., RSRP measurements, RSSI measurements, RSRQ measurements, and/or CQI values) or other suitable measurements associated with the source cell and/or one or more neighboring cells. In some examples, as shown by reference number 335, the source network node 310 may configure a conditional handover based on the measurement report provided by the UE 305 or other suitable information. For example, as shown by reference number 340, the source network node 310 may transmit a conditional handover request to the target network node 315 to instruct the target network node 315 to prepare for a potential handover. The source network node 310 may communicate RRC context information associated with the UE 305 and/or configuration information associated with the UE 305 to the target network node 315. The target network node 315 may prepare for the potential handover by reserving resources for the UE 305. After reserving the resources, as shown by reference number 345, the target network node 315 may transmit an ACK in response to the conditional handover request to the source network node 310.

As further shown by reference number 350, the source network node 310 may transmit, and the UE 305 may receive, a conditional handover configuration. For example, in some aspects, the conditional handover configuration may include a handover command to trigger a handover from the source network node 310 to the target network node 315, and the conditional handover configuration may further indicate one or more conditions associated with the conditional handover command. Accordingly, the UE 305 may generally store the conditional handover command, and may execute the conditional handover command only when an associated condition is satisfied. For example, in some aspects, the one or more conditions may instruct the UE 305 to execute the conditional handover command when a measurement associated with the source network node 310 fails to satisfy a threshold (e.g., an A2 measurement event occurs), when a difference between a measurement associated with the target network node 315 and a measurement associated with the source network node 310 satisfies a threshold (e.g., an A3 measurement event occurs), when a measurement associated with the target network node 315 satisfies a threshold (e.g., an A4 measurement event occurs), when a measurement associated with the source network node 310 fails to satisfy a first threshold and a measurement associated with the target network node 315 satisfies a second threshold (e.g., an A5 measurement event occurs), and/or when a difference between a measurement associated with the target network node 315 and a measurement associated with a secondary cell (SCell) satisfies a threshold (e.g., an A6 measurement event occurs), among other examples. Additionally, or alternatively, the one or more conditions may indicate that a handover to the target network node 315 is cancelled (e.g., the conditional handover command is not executed) when a measurement associated with the source network node 310 satisfies a threshold before a TTT parameter expires.

Accordingly, as shown by reference number 355, the UE 305 may evaluate the conditional handover condition indicated by the source network node 310. For example, the UE 305 may obtain a measurement associated with the source network node 310 and/or a measurement associated with the target network node 315, and may determine whether the measurement associated with the source network node 310 and/or the measurement associated with the target network node 315 satisfy the condition associated with the conditional handover command. In cases where the condition associated with the conditional handover command is not satisfied, the UE 305 does not execute the conditional handover command, and may re-evaluate the condition associated with the conditional handover command at a later time. Alternatively, as shown by reference number 360, the UE 305 may determine that the condition associated with the conditional handover command is satisfied. In such cases, as shown by reference number 365, the UE 305 executes the conditional handover command, and communicates with the target network node 315 to confirm the conditional handover. As shown by reference number 370, the target network node 315 may perform a path switch to switch a user plane path of the UE 305 from the source network node 310 to the target network node 315. Prior to switching the user plane path, downlink communications for the UE 305 may be routed through the source network node 310. After the user plane path is switched, downlink communications for the UE 305 may be routed through the target network node 315. Upon completing the switch of the user plane path, a core network node may transmit an end marker message to the source network node 310 o signal completion of the user plane path switch, and the target network node 315 may communicate with the source network node 310 to release a context associated with the UE 305 at the source network node 310.

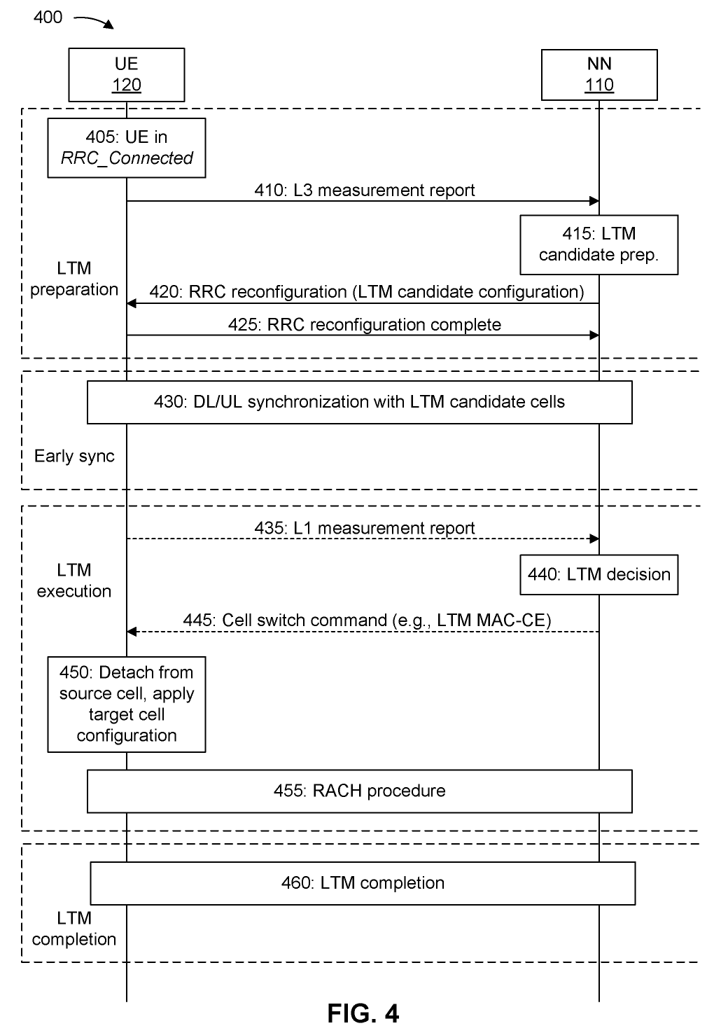

FIG. 4 illustrates an example 400 of an L1 or Layer 2 (L2) triggered mobility (LTM) procedure. As shown in FIG. 4, example 400 includes communication between a network node 110 and a UE 120. In some aspects, the network node 110 and the UE 120 may communicate in a wireless network, such as wireless communication network 100. The network node 110 and the UE 120 may communicate via a wireless access link, which may include an uplink and a downlink.

In some examples, the network node 110 may instruct the UE 120 to change or switch serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a Layer 3 (L3) handover procedure, such as the MBB handover procedure shown in FIG. 2, which may be referred to herein as a legacy handover procedure. In an L3 handover procedure, the network node 110 may transmit, to the UE 120, an RRC reconfiguration message indicating that the UE 120 is to perform a handover procedure to a target cell. For example, the network node 110 may transmit the reconfiguration message triggering the handover to the target cell in response to the UE 120 providing the network node 110 with an L3 measurement report indicating signal strength measurements associated with one or more cells (e.g., measurements associated with the source cell and/or one or more neighboring cells). In response to the RRC reconfiguration message, the UE 120 may communicate with the source cell and the target cell to detach from the source cell and connect to the target cell (e.g., the UE 120 may perform a contention-free RACH procedure in the target cell to establish an RRC connection with the target cell in accordance with a contention-free random access (CFRA) configuration indicated in the RRC reconfiguration message). Once handover is complete, the target cell may communicate with a UPF of a core network to instruct the UPF to switch a user plane path of the UE 120 from the source cell to the target cell. The target cell may also communicate with the source cell to indicate that handover is complete and that the source cell may be released.

As described herein, L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the LTM procedure shown in FIG. 4, which uses L1/L2 signaling to significantly reduce a handover latency relative to a legacy L3 handover procedure. For example, as shown in FIG. 4, the LTM procedure may include an LTM preparation phase, an early synchronization phase (shown as “early sync” in FIG. 4), an LTM execution phase, and an LTM completion phase.

As shown by reference number 405, during the LTM preparation phase, the UE 120 may be in an RRC connected state (sometimes referred to as RRC_Connected) with a source cell provided by the network node 110. As shown by reference number 410, the UE 120 may transmit, and the network node 110 may receive, an L3 measurement report (sometimes referred to as a MeasurementReport), which may indicate measurements related to a signal strength (e.g., RSRP measurements, RSSI measurements, RSRQ measurements, and/or CQI values) or other suitable measurements associated with the source cell and/or one or more neighboring cells. In some examples, based at least in part on the L3 measurement report or other information, the network node 110 may configure LTM for UE 120. Accordingly, as shown by reference number 415, the network node 110 may perform LTM candidate preparation. For example, during the LTM candidate preparation, the network node 110 may obtain configuration information for one or more LTM candidate cells (e.g., one or more parameters related to an identity for each LTM candidate cell, a synchronization and/or measurement configuration for each LTM candidate cell, and/or a full RRC configuration message associated with each LTM candidate cell, among other examples).

As shown by reference number 420, the network node 110 may transmit, and the UE 120 may receive, an RRC reconfiguration message (sometimes referred to as an RRCReconfiguration message), which may include an LTM configuration. More particularly, the LTM configuration included in the RRC reconfiguration message may indicate the configuration information for one or more LTM candidate cells (e.g., obtained during the LTM candidate preparation), which may be candidate cells to become a serving cell of the UE 120 and/or cells for which the UE 120 may later be triggered to perform an LTM procedure. As shown by reference number 425, the UE 120 may store the configuration information for the one or more LTM candidate cells and may transmit, in response to the RRC reconfiguration message, an RRC reconfiguration complete message (sometimes referred to as an RRCReconfigurationComplete message) to the network node 110.

As shown by reference number 430, during the early synchronization phase, the UE 120 may optionally perform downlink synchronization and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 455. For example, the UE 120 may acquire the timing advance for an LTM candidate cell in accordance with a measured timing advance indicated in the configuration information for the LTM candidate cell and/or by using PRACH transmission parameters indicated in the configuration information (e.g., in an early synchronization configuration, which may be provided in an EarlyUL-SyncConfig parameter) to transmit a PRACH to the LTM candidate cell.

As shown by reference number 435, during the LTM execution phase, the UE 120 may obtain L1 measurements associated with the configured LTM candidate cells, and may transmit, to the network node 110, one or more L1 measurement reports associated with the configured LTM candidate cells. As shown by reference number 440, based at least in part on the L1 measurement report(s), the network node 110 may decide to execute an LTM cell switch to an LTM target cell (e.g., included among the configured LTM candidate cells). Accordingly, as shown by reference number 445, the network node 110 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the LTM target cell. As shown by reference number 450, based at least in part on the cell switch command, the UE 120 may switch to the configuration of the LTM target cell (e.g., the UE 120 may detach from the source cell and apply the configuration of the LTM target cell). Moreover, as shown by reference number 455, the UE 120 may perform a RACH procedure towards the LTM target cell, such as when a timing advance associated with the target cell is not available (e.g., in cases in which the UE 120 did not perform the early synchronization described above in connection with reference number 430 and/or the LTM cell switch command does not indicate a valid timing advance for the LTM target cell).

As shown by reference number 460, during the LTM completion phase, the UE 120 may indicate successful completion of the LTM cell switch towards the LTM target cell. In this way, a cell switch or handover to a target cell may be performed using L1/L2 signaling, which is associated with less overhead than an L3 handover procedure and/or a reduced latency relative to an L3 handover procedure.

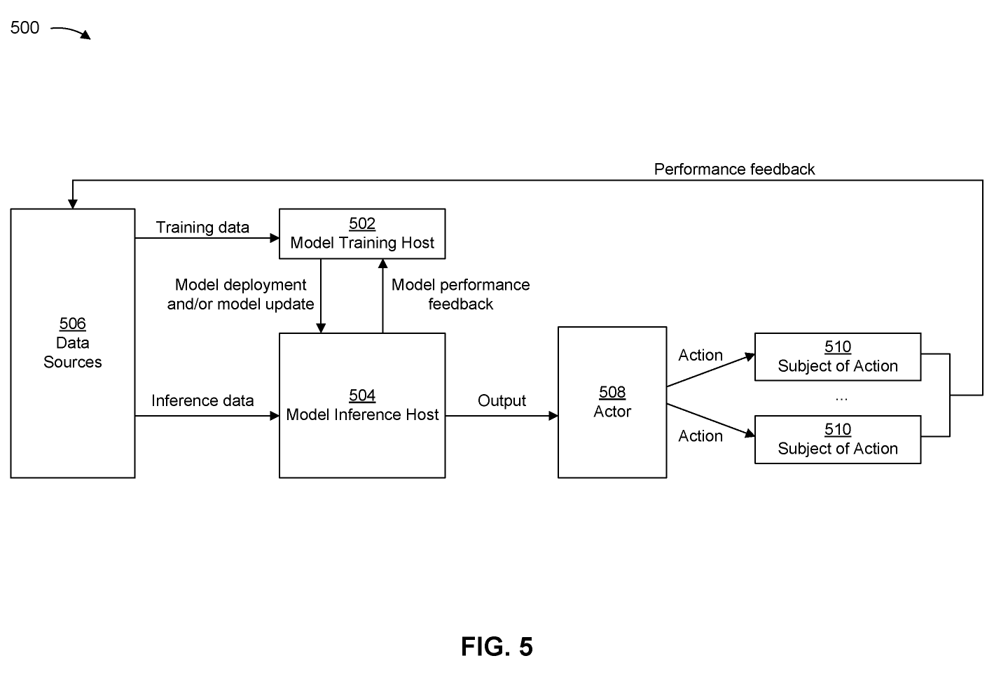

FIG. 5 illustrates an example architecture 500 of a functional framework for RAN intelligence enabled by data collection. In some scenarios, the functional framework for RAN intelligence may be enabled by further enhancement of data collection through use cases and/or examples. For example, principles or algorithms for RAN intelligence enabled by AI/ML and the associated functional framework (e.g., the AI/ML functionality and/or the input/output of the component for AI/ML enabled optimization) have been utilized or studied to identify the benefits of AI/ML enabled RAN for various possible use cases (e.g., beam management, network energy savings, load balancing, and/or mobility management, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, a base station (e.g., a gNB), a CU, a DU, and/or an RU, among other examples. In addition, the actor 508 may depend on a type of tasks performed by the model inference host 504, a type of inference data provided to the model inference host 504, and/or a type of output produced by the model inference host 504. For example, if the output from the model inference host 504 is associated with position determination, the actor 508 may be a UE, a DU or an RU. In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., an NR measurement), may input the measurement to the AI/ML model at the model inference host 504 (or may provide the measurement to the model inference host 504), and may act based on an output of the AI/ML model.

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. If the actor 508 determines to act based on the output, in some examples, the actor 508 may indicate the action to at least one subject of action 510.

The data sources 506 may also be configured for collecting data that is used as training data for training an AI/ML model or as inference data for feeding an AI/ML model inference operation. For example, the data sources 506 may collect data from one or more core network and/or RAN entities, which may include the actor 508 or the subject of action 510, and provide the collected data to the model training host 502 for AI/ML model training. In some aspects, the model training host 502 may be co-located with the model inference host 504 and/or the actor 508. For example, the actor 508 or the subject of action 510 may provide performance feedback associated with the beam configuration to the data sources 506, where the performance feedback may be used by the model training host 502 for monitoring or evaluating the AI/ML model performance, such as whether the output (e.g., prediction) provided to the actor 508 is accurate. In some examples, the model training host 502 may monitor or evaluate AI/ML model performance using a training position value, which may be provided by a node (e.g., a UE 120 or a network node 110), as described elsewhere herein. In some examples, if the output provided by the actor 508 is inaccurate (or the accuracy is below an accuracy threshold), then the model training host 502 may determine to modify or retrain the AI/ML model used by the model inference host, such as via an AI/ML model deployment/update.

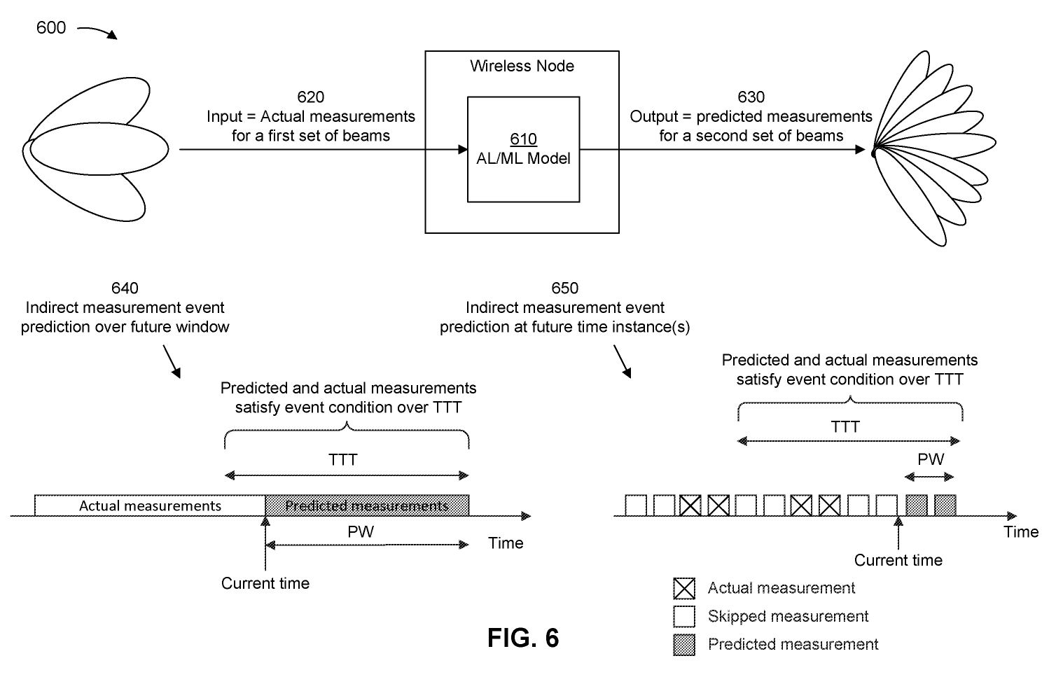

FIG. 6 illustrates an example 600 of AI/ML based beam management. As shown in FIG. 6, an AI/ML model 610 may be deployed at or on a wireless node, which may correspond to the UE 120 and/or the network node 110 described elsewhere herein. For example, a model inference host may be deployed at, or on, a UE 120, for use in generating one or more UE-side predictions or inferences that may be indicated in a prediction or inference report sent to a network node 110, or the model inference host may be deployed at, or on, a network node 110, for use in generating one or more network-side predictions or inferences that may be indicated in a prediction or inference results indication sent to a UE 120. In some aspects, as described herein, the AI/ML model 610 may enable the wireless node to determine one or more inferences or predictions based on data input to the AI/ML model 610 using one or more AI/ML functionalities. As described herein, an AI/ML “functionality” may be a supported AI/ML functionality (e.g., referring to capabilities associated with a UE 120 related to one or more AI/ML-specific feature groups (FGs)), an applicable AI/ML functionality (e.g., referring to an inference configuration indicated by a network node 110 in a CSI report configuration or a set of inference-related parameters or information indicated by a UE 120), and/or an activated AI/ML functionality (e.g., referring to an AI/ML functionality enabled based on a CSI framework). Accordingly, as described herein, the meaning and granularity of an AI/ML functionality may be the same or may differ for supported AI/ML functionalities, applicable AI/ML functionalities, and activated AI/ML functionalities.

For example, as shown by reference number 620, an input to the AI/ML model 610 may include measurements associated with a first set of beams. For example, a network node 110 may transmit one or more signals using respective beams from the first set of beams. The UE 120 may perform measurements (e.g., L1-RSRP measurements, L1-SINR measurements, L3-RSRP measurements, L3-SINR measurements, or other suitable measurements) of the first set of beams to obtain a first set of measurements. For example, each beam, from the first set of beams, may be associated with one or more measurements performed by the UE 120. The UE 120 may input the first set of measurements (e.g., L1/RSRP/L1-SINR and/or L3-RSRP/L3-SINR measurement values) into the AI/ML model 610 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 630, the AI/ML model 610 may output one or more predictions. The one or more predictions may include predicted measurement values (e.g., predicted L1-RSRP/L1-SINR and/or L3-RSRP/L3-SINR measurement values) associated with the second set of beams. In this way, predicting measurement values associated with the second set of beams without actually measuring the second set of beams may reduce a quantity of beam measurements that are performed by the UE 120, thereby conserving power of the UE 120 and/or network resources that would have otherwise been used to measure all of the beams included in the first set of beams and the second set of beams. This type of prediction may be referred to as a codebook based spatial domain selection or prediction.

As another example, an output of the AI/ML model 610 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 610. This may enable the AI/ML model 610 to output codebook based and/or non-codebook based predictions for a measurement value, an AoD, and/or an AoA, among other examples, of a beam at a future time. The output(s) of the AI/ML model 610, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams associated with actual measurements may be referred to as Set B beams and the second set of beams associated with predicted measurements may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., SSBs, unrefined beams, or other beams having a beam width that satisfies a first threshold) and the second set of beams (e.g., the Set A beams) may include narrow beams (e.g., CSI-RS beams, refined beams, or other beams having a beam width that satisfies a second threshold). In one example, the AI/ML model 610 may be used to perform spatial-domain downlink beam prediction for beams included in the Set A beams based on measurement results of beams included in the Set B beams. As another example, the AI/ML model 610 may be used to perform temporal downlink beam prediction for beams included in the Set A beams based on historic measurement results of beams included in the Set B beams. In cases where the AI/ML model 610 is used to perform temporal downlink beam prediction, the Set A beams may be the same as the Set B beams (e.g., for pure temporal beam prediction), or the Set A beams may be different from the Set B beams (e.g., with or without overlap, to enable spatial and temporal beam prediction). In general, as described herein, the AI/ML model 610 may be used for spatial and/or temporal beam prediction at a network node 110 or a UE 120, and may be supported for single-cell scenarios.

Additionally, or alternatively, in some cases, the AI/ML model 610 may be used as a predictive model for making other mobility-related predictions, such as temporal measurement event prediction and/or spatial measurement event prediction, in accordance with actual and/or predicted measurements for one or more beams and/or reference signals associated with a serving cell and one or more neighbor cells. For example, in handover procedures such as the MBB handover procedure described herein with reference to FIG. 2, the conditional handover procedure described herein with reference to FIG. 3, and/or the LTM handover procedure described herein with reference to FIG. 4, a UE 120 may transmit a measurement report to a serving network node when one or more measurement events are detected. Additionally, or alternatively, a network node may make a decision to initiate or cancel a handover from a source (serving) cell to a target (neighbor) cell when one or more measurement events are detected.

For example, a measurement report and/or a handover decision may be triggered by an A1 measurement event that occurs when a measurement associated with a serving cell exceeds or otherwise satisfies a threshold (e.g., indicating that a handover may be cancelled), an A2 measurement event that occurs when a measurement associated with a serving cell falls below or otherwise fails to satisfy a threshold, an A3 measurement event that occurs when a measurement associated with a neighbor cell exceeds a measurement associated with a serving cell, an A4 measurement event that occurs when a measurement associated with a neighbor cell exceeds or otherwise satisfies a threshold, an A5 measurement event that occurs when a measurement associated with a serving cell falls below a first threshold and a measurement associated with a neighbor cell exceeds a second threshold, and/or an A6 measurement event that occurs when a difference between a measurement associated with a serving cell and a measurement associated with a neighbor cell satisfies a threshold. In other examples, B1 and B2 measurement events define conditions for handovers to inter-RAT neighbor cells, and/or other suitable measurement events may be defined or configured.

However, triggering measurement reports and/or handover procedures according to actual measurement events associated with real-time measurements is reactive in nature, which may result in handover failures or handover delays (e.g., because a measurement report transmitted by the UE 120 may not reach the serving cell when the signal quality has significantly degraded). Reactive handover procedures may lead to suboptimal decisions, such as delayed transitions, dropped connections, or unnecessary handovers, which degrade network performance and user experience. Accordingly, in some examples, the AI/ML model 610 may be used for measurement event prediction, such as direct temporal measurement event prediction, indirect temporal measurement event prediction, or spatial measurement event prediction. For example, when used for direct temporal measurement event prediction, the UE 120 may obtain actual measurements associated with a serving cell and one or more neighbor cells, and may predict whether and/or when a future measurement event will occur (e.g., according to trends or patterns indicating future degradation for channel quality in the serving cell and/or future improvement for channel quality in a neighbor cell). In another example, as shown by reference number 640 in FIG. 6, a UE 120 may use the AI/ML model 610 for indirect temporal measurement event prediction, where future measurement results are predicted using the AI/ML model 610. Accordingly, the predicted measurement results may be used alone or in combination with actual historical measurement results to derive a prediction as to whether a future measurement event will occur during a prediction window (shown as PW) without further involvement of the AI/ML model 610. For example, a future measurement event may be predicted when one or more predicted measurements, or one or more predicted measurements and one or more historical measurements, are predicted to satisfy a condition and continue to satisfy the condition until a TTT expires. In another example of indirect measurement event prediction, as shown by reference number 650, the UE 120 may similarly use the AI/ML model 610 to predict future measurement results, which may be used alone or in combination with actual historical measurement results to derive a prediction as to whether a future measurement event will occur at one or more time instances within a prediction window without further involvement of the AI/ML model 610. For example, a future measurement event may be predicted when one or more predicted measurements, or one or more predicted measurements and one or more historical measurements, are predicted to satisfy a condition and continue to satisfy the condition until a TTT expires. In addition, in the example shown by reference number 650, the UE 120 may perform one or more actual measurements that are used to predict the measurements within the prediction window, and may skip one or more measurement occasions (e.g., to conserve power). Additionally, or alternatively, for measurement event prediction in a spatial domain, current measurement events may be inferred and/or future measurement events may be predicted according to predicted measurements for one or more neighbor cells that are not actually measured (e.g., similar to spatial-domain downlink beam prediction).

However, in cases where a predictive model, such as AI/ML model 610, is used to predict future measurement events, an important issue is to monitor performance of the predictive model to ensure that the predictions or inferences made by the predictive model are accurate and reliable, to enable adaptation to changes in an environment and/or data patterns to optimize computational and network resources and ensure that the predictive model does not introduce unnecessary overhead or inefficiencies (e.g., when the predictive model is performing poorly), to ensure that predicted outcomes closely align with actual measurements and/or measurement events, and/or to otherwise obtain other insights that are important for LCM decisions, such as when to update, retrain, reconfigure, or retire the predictive model.

However, performance monitoring for AI/ML models that are used in wireless networks, such as predictive models for predicting measurement events, poses various challenges due to the need for coordination between the UE 120 and the network. For example, a UE 120 may operate in different performance monitoring modes, such as an active performance monitoring mode (e.g., where reports are transmitted for every predicted measurement event occurrence) or inactive monitoring (e.g., where reports are transmitted after storing statistics over a configured observation window). Additionally, or alternatively, the UE 120 may switch between direct measurement event prediction (e.g., where actual measurements are used to predict future measurement events) and indirect event prediction (e.g., where predicted measurements are used alone or in combination with historical measurements to predict future measurement events). The variations among different performance monitoring modes or configurations may have various tradeoffs, such that a network node 110 may adapt performance monitoring configurations and signaling mechanisms to support effective and efficient performance monitoring. For example, a network node 110 may adapt a performance monitoring configuration for a model used to predict future measurement events to ensure that predicted measurement event times closely align with actual measurement event times and that handover attempts triggered by predicted measurement events are successful, to manage tradeoffs between frequent reporting that increases signaling overhead and periodic reporting that delay corrective actions, to address scenarios where a UE 120 may not have access to ground truth information about whether or when an actual measurement event occurred due to early initiation of a handover, and/or to support dynamic performance monitoring modes in accordance with capabilities of a UE 120, network requirements, and/or operational conditions, among other examples.

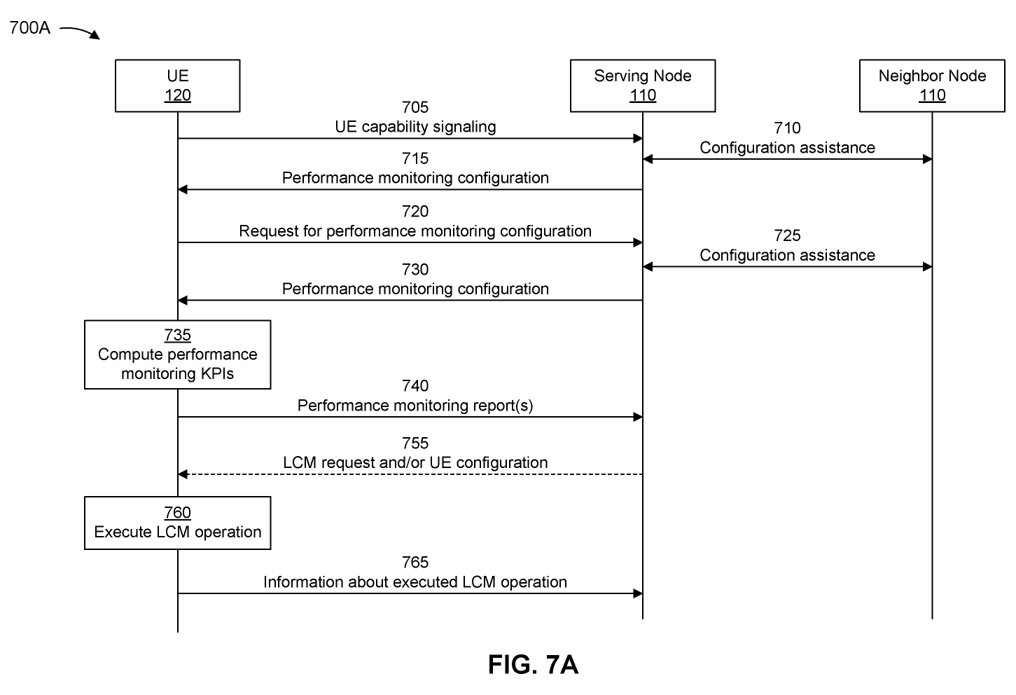

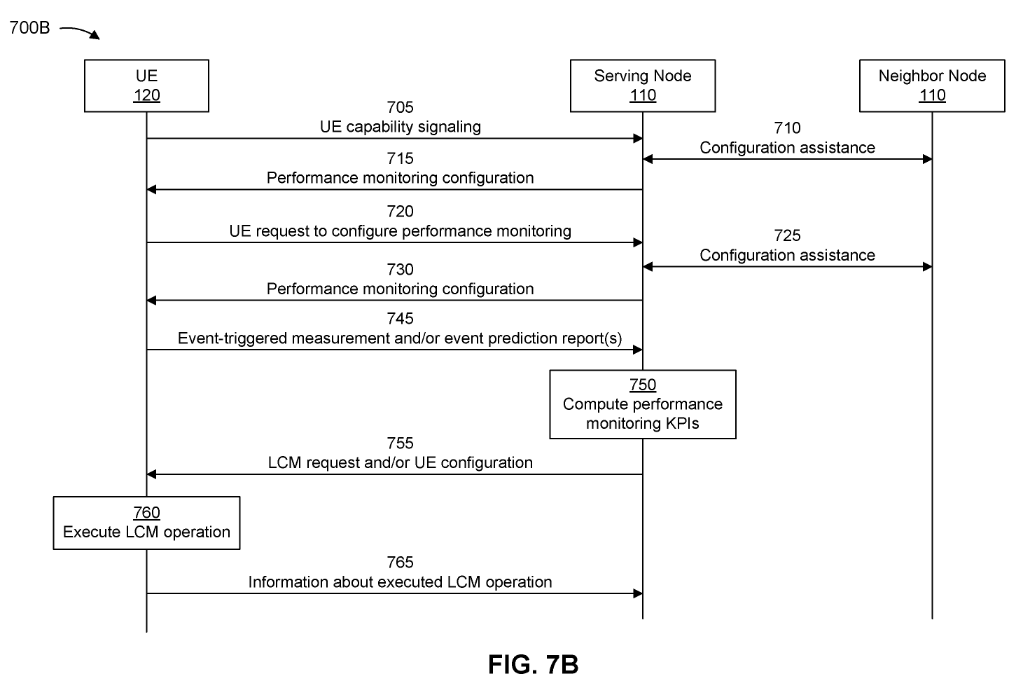

FIGS. 7A-7B illustrate examples 700A and 700B associated with performance monitoring for measurement event prediction. As shown in FIGS. 7A-7B, examples 700A and 700B include communication between a UE 120, a serving network node 110 (e.g., a network node 110 providing a serving cell for the UE 120), and a neighbor network node 110 (e.g., a network node 110 providing a neighbor cell for the UE 120). In some aspects, the UE 120, the serving network node 110, and the neighbor network node 110 may be included in a wireless network, such as wireless communication network 100. The UE 120 may communicate with the serving network node 110 and/or the neighbor network node 110 via a wireless access link, which may include an uplink and a downlink, and the serving network node 110 and the neighbor network node 110 may communicate via a backhaul, such as an Xn interface.

In some aspects, FIGS. 7A-7B depict example operations associated with the UE 120 and the serving network node 110 communicating configuration information for using a predictive model (e.g., an AI/ML model) for measurement event prediction to enable efficient handover in a wireless communication system and for monitoring performance of the predictive model to ensure that predicted measurement events are accurate and reliable and/or to adjust one or more measurement configurations and/or model configurations to facilitate accurate measurement event predictions and improve handover success rates, among other examples. In particular, as described herein, FIG. 7A depicts example operations associated with UE-side or UE-assisted performance monitoring for measurement event prediction, and FIG. 7B depicts example operations associated with network-side performance monitoring for measurement event prediction

In some aspects, as shown by reference number 705 in FIGS. 7A and 7B, the UE 120 may transmit, and the serving network node 110 may receive, capability information associated with the UE 120. The capability information may be included in a capability report that the UE 120 transmits to the serving network node 110 in response to a capability inquiry received from the serving network node 110. In some aspects, the UE 120 may transmit the capability information via an uplink communication, a sidelink communication, a unicast communication, a broadcast communication, a UE assistance information (UAI) communication, a UCI communication, a MAC-CE communication, an RRC communication, a PUCCH, or a PUSCH, among other examples. The capability information may indicate one or more parameters associated with respective capabilities of the UE 120, such as capabilities that relate to measurement event prediction using a predictive model and/or capabilities that relate to monitoring performance for a predictive model used for measurement event prediction. The one or more parameters may be indicated via respective information elements included in a capability report.

As described herein, the capability information transmitted by the UE 120 may generally indicate whether the UE 120 supports one or more features related to using and/or monitoring performance for a predictive model for measurement events or one or more parameters related to the one or more features. For example, the capability information may indicate a capability or parameter for measuring or computing one or more KPIs that relate to performance of the predictive model, a capability or parameter for measuring one or more serving cells or neighbor cells (e.g., indicating the one or more serving cells or neighbor cells or a maximum number of serving cells or neighbor cells that can be measured) for performance monitoring purposes, and/or whether the UE 120 supports UE-side performance monitoring or UE-assisted performance monitoring (e.g., as described herein with respect to FIG. 7A) or network-side performance monitoring (e.g., as described herein with respect to FIG. 7B).

In other examples, the capability information may indicate capabilities or parameters related to direct and/or indirect measurement event prediction, spatial measurement event prediction, or other measurement event prediction types, certain measurement events (e.g., A1-A6 measurement events) that the UE 120 has a capability to predict or monitor performance for predicted measurement events, reporting the outcome of a handover and associated measurements, such as the success or failure of the handover to the target cell, and/or whether a predicted measurement event occurred prior to handover initiation. In other examples, the capability information may indicate a capability or parameter for reporting source cell and target cell measurements before and/or after a handover, and/or support for extended reporting over multiple handover events, among other examples. One or more operations described herein may be based on capability information. For example, the UE 120 may perform a communication in accordance with the capability information, or may receive configuration information in accordance with the capability information. Additionally, or alternatively, as shown by reference number 710 in FIGS. 7A-7B, the serving network node 110 and the neighbor network node 110 may exchange configuration assistance information accordance with the capability information, such as configuration information for one or more beams or reference signals associated with the neighbor network node 110 (e.g., for the UE 120 to measure a neighbor cell associated with the neighbor network node 110).

As shown by reference number 715 in FIGS. 7A-7B, the network node 110 may transmit, and the UE 120 may receive, a performance monitoring configuration in accordance with the capability information. In some aspects, the UE 120 may receive configuration information including the performance monitoring configuration via one or more of system information signaling (e.g., a master information block (MIB) or a system information block (SIB), among other examples), RRC signaling, one or more MAC-CEs, or physical layer signaling (e.g., DCI), among other examples. In some aspects, the performance monitoring configuration may indicate one or more candidate performance monitoring configurations or parameters for a predictive model for measurement event prediction.

For example, in some aspects, the performance monitoring configuration may indicate parameters such as one or more measurement event prediction types (e.g., predicted intra-RAT measurement events, such as A1-A6 measurement events, inter-RAT measurement events, such as B1-B2 measurement events, or any suitable subset or combination of predicted measurement events) for performance monitoring, one or more performance monitoring types (e.g., UE-side, UE-assisted, or network-side performance monitoring), performance monitoring for direct and/or indirect measurement event prediction in a temporal domain and/or measurement event prediction in a spatial domain, and/or a mapping between a performance monitoring configuration and an inferencing or prediction configuration for the predictive model that is used to predict measurement events. Additionally, or alternatively, in some aspects, the performance monitoring configuration may indicate a configuration for computing one or more performance monitoring KPIs, such as an event time difference (EDT) that defines a maximum time interval around a predicted time for a predicted measurement event in which the UE 120 is to check whether a measurement event based on actual measurements (e.g., a ground truth measurement event) has occurred and/or whether the UE 120 should report whether an actual (ground truth) measurement event corresponding to a predicted measurement event occurred. Additionally, or alternatively, the performance monitoring configuration may indicate a configuration for computing KPIs such as precision, recall, accuracy, and/or F1 scores for true (e.g., correct) measurement event predictions, false (e.g., incorrect) measurement event predictions, missed (e.g., not predicted) measurement event detection, and/or null measurement event detection (e.g., where the predictive model correctly predicts or detects a null measurement event, where a condition for a measurement is satisfied but do not continue to be satisfied for an entire TTT duration).

In some aspects, the performance monitoring configuration may indicate various reporting criteria for each performance monitoring type (e.g., UE-side, UE-assisted, or network-side), predicted measurement event type (e.g., A1-A6), and/or measurement event prediction (e.g., direct or indirect). For example, in some aspects, the reporting criteria may indicate the content of the performance monitoring reports to be transmitted to the network, a configuration for cell and beam measurements and measurement predictions for serving cells (including PCells, PSCells, and SCells) and neighbor or candidate cells. In addition, the reporting criteria may indicate criteria or conditions for transmitting the performance monitoring reports, such as a periodicity configuration for periodic performance monitoring reports or one or more event configurations for event-triggered performance monitoring reports (e.g., where a performance monitoring report is transmitted per-predicted measurement event).

As described herein, the performance monitoring configuration provided to the UE 120 may indicate one or more candidate performance monitoring configurations or parameters for a predictive model for measurement event prediction Accordingly, the one or more candidate configurations or communication parameters may be selected, activated, or deactivated by a subsequent indication. For example, as shown by reference number 720 in FIGS. 7A-7B, the UE 120 may transmit, and the network node 110 may receive, a request to enable a performance monitoring configuration, where the request can indicate a subset of the candidate performance monitoring configurations or performance monitoring parameters to select, activate, or deactivate. For example, in some aspects, the request may indicate certain performance monitoring configurations or parameters that are supported at a current time (e.g., in accordance with available processing capacity or battery power, or other factors), such as certain measurement events (e.g., A3 and A5 measurement events only), a performance monitoring type (e.g., UE-side, UE-assisted, or network-side), measurement event prediction types (e.g., direct or indirect), performance monitoring report triggers (e.g., periodic or event-triggered), and/or configurations for cell measurements and predictions for serving cells and/or neighbor cells. In some aspects, as shown by reference number 725 in FIGS. 7A-7B, the serving network node 110 and the neighbor network node 110 may exchange additional configuration assistance information accordance with the current supported capabilities indicated in the request from the UE 120. As shown by reference number 730, the serving network node 110 may then transmit, and the UE 120 may receive, an active performance monitoring configuration in accordance with the supported capabilities indicated in the request and/or the additional configuration assistance information received from the neighbor network node 110. In some aspects, the performance monitoring configuration information may include an indication of a selection of one or more performance monitoring configuration parameters (e.g., a selection of the one or more configuration parameters already known to the UE 120 or previously indicated by the serving network node 110), or explicit configuration information for the UE 120 to use to configure the UE 120, among other examples. Additionally, or alternatively, the active performance monitoring configuration may configure network-side performance monitoring, in which case the active performance monitoring configuration may configure one or more parameters related to the UE 120 transmitting measurement reports triggered by measurement events and/or measurement event prediction reports triggered by predicted measurement events.

In some examples, the configuration information may not be expressly signaled to the UE 120. For example, in some aspects, the configuration information may at least partially be defined by a wireless communication standard. In such examples, the serving network node 110 may not explicitly indicate the performance monitoring configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard (e.g., rather than explicitly indicating the information).

In some aspects, as shown by reference number 735 in FIG. 7A, the UE 120 may compute one or more performance monitoring KPIs for the predictive model in accordance with predicted measurement events that are obtained using the predictive model when configured to perform UE-assisted or UE-side performance monitoring. For example, for direct measurement event prediction, the UE 120 may obtain actual measurements for one or more serving cells and/or neighbor cells, and may predict one or more future measurement events in accordance with the actual measurements for one or more serving cells and/or neighbor cells. Additionally, or alternatively, for indirect measurement event prediction, the UE 120 may obtain predicted measurements for one or more serving cells and/or neighbor cells, and may use the predicted measurements alone or in combination with one or more actual historical measurements to predict future measurement events. Furthermore, in some cases, the predicted measurement events may result in one or more attempted handovers from a source cell to a target cell. Accordingly, the UE 120 may collect statistics related to the predicted measurement events, attempted handovers, or other parameters to compute the performance monitoring KPIs for the predictive model.

For example, in some aspects, the UE 120 may compute one or more KPIs with respect to each predicted measurement event type and/or for each measurement event prediction type (e.g., direct or indirect). For example, the KPIs may include a first counter value (n3) for true or correct event prediction, which is incremented each time that an actual measurement event occurs within the ETD around a predicted measurement event, a second counter value (n1) for false or incorrect event prediction, which is incremented each time that an actual measurement event does not occur within the ETD around a predicted measurement event, a third counter value (n2) for missed measurement event detection, which is incremented each time that no measurement event is predicted within the ETD around an actual measurement event, and/or a fourth counter value (n4) for null measurement event detection, which is incremented each time that a null handover event is detected (e.g., where a null handover event is when the condition for a measurement event are satisfied by a serving cell and/or neighbor cell measurement, but a handover does not occur because the condition does not remain satisfied for the TTT associated with the measurement event).

Additionally, or alternatively, the KPIs that the UE 120 computes for each predicted measurement event type and/or for each measurement event prediction type may include various performance parameters for the predictive model, such as accuracy, precision, recall, and/or F1 scores for measurement events and/or null handover events. For example, the precision score for a predicted measurement event type may be defined as n3/(n1 + n3) (e.g., the number of true event predictions divided by the sum of true measurement event predictions and false measurement event detections), the recall score for a predicted measurement event type may be defined as n3/(n2 + n3) (e.g., the number of true event predictions divided by the sum of missed measurement event detections and true measurement event detections), and the F1 score for a predicted measurement event type may be defined as 2 × precision × recall / (precision + recall). Similarly, for null handover events, the null precision score may be defined as n4/(n4 + n2) (e.g., the number of null handover event detections divided by the sum of null handover event detections and missed measurement event detections), the null recall score may be defined as n4/(n4 + n1) (e.g., the number of null handover event detections divided by the sum of null handover event detections and true measurement event detections), and the null F1 score may be defined as 2 × null precision × null recall / (null precision + null recall). In addition, accuracy for null handover event detection may be defined as (n3 + n4) / (n1 + n2 + n3 + n4).

In some aspects, for UE-side or UE-assisted performance monitoring, the KPIs that are computed for each measurement event type, measurement event prediction type, and/or null handover event may be collected and computed over a configured time duration before the UE 120 transmits the KPIs in a performance monitoring report. Alternatively, in some aspects, the KPIs may be computed and transmitted by the UE 120 in a performance monitoring report after each predicted measurement event occurrence. In some aspects, the KPIs may be provided for one or more cells, depending on a measurement event type. For example, the one or more KPIs may be provided for each of one or more serving cells for predicted A1 or A2 measurement events, for each of one or more source cell and neighbor cell pairs for predicted A3 or A5 measurement events, for each of one or more neighbor cells for predicted A4 measurement events, and/or for each of one or more SCell and neighbor cell pairs for predicted A6 measurement events, among other examples. In some aspects, the one or more KPIs may each be associated with a functionality or logical model identifier for the predictive model used for measurement event prediction (e.g., where the same predictive model may be used in one or more cells within a given area).

In some aspects, for UE-side or UE-assisted performance monitoring, the KPIs that are computed may include one or more system-level performance KPIs. For example, the system-level performance KPIs may include an average RSRP, RSRQ, or SINR measurement difference between a serving PCell and the best neighbor cell (e.g., where higher values for the average generally indicates that the measurement event prediction is performing well, and lower values for the average generally indicates that the measurement event prediction is performing poorly). Additionally, or alternatively, the system-level performance KPIs may include an average RSRP, RSRQ, SINR, MCS, or other performance metric at the serving PCell and the target cell before and after one or more handovers, calculated over one or more configured time windows, and/or a time difference or average time difference between a crossover time during which the serving PCell and the target cell have equal RSRP, RSRQ, SINR, or other measurements and the actual handover time.

As shown by reference number 740 in FIG. 7A, the UE 120 may transmit, and the serving network node 110 may receive, one or more performance monitoring reports that each indicate one or more KPIs for predicted measurement events, measurement event prediction types, and/or null handover event predictions, as described herein. In some aspects, the one or more performance monitoring reports may be transmitted according to a periodicity indicated in the performance monitoring configuration. In some aspects, the periodicity may be set to a relatively high value (e.g., on the order of seconds, minutes, hours, or even days for certain handover events, such as when the UE 120 moves slowly or is in a large cell, resulting in a handover after a long period of time). Additionally, or alternatively, one or more performance monitoring reports may be event-triggered, where the triggering event may be a request from the serving network node 110, a measurement event prediction, an attempted handover, or one or more KPIs satisfy a threshold or a configured range (e.g., the UE 120 may transmit a performance monitoring report when a KPI for a predicted measurement event type, handover success rate, or other parameter falls below or above a threshold, or moves within or outside a range). Additionally, or alternatively, the UE 120 may be configured with a prohibit timer that may be started when a performance monitoring report is transmitted, and the UE 120 may be prohibited from transmitting another performance monitoring report while the prohibit timer is not expired (e.g., to prevent frequent performance monitoring report transmissions).

In some aspects, in an active performance monitoring configuration, the UE 120 may transmit the performance monitoring reports after every predicted measurement event occurrence, and legacy measurement reporting based on actual measurements and measurement events may be disabled. Alternatively, in an inactive performance monitoring configuration, the UE 120 may monitor performance for measurement event predictions, and may transmit performance monitoring reports that indicate statistics after a configured observation window, while legacy measurement reporting based on actual measurements and measurement events is disabled. In such examples, the configured observation window may have a long duration to ensure that the statistics provided to the serving network node 110 are meaningful. In addition, the serving network node 110 may collect (e.g., crowdsource) statistical performance monitoring metrics from multiple UEs 120 that perform handovers between the same source and target cells or otherwise perform measurement event prediction with similar parameters. In some aspects, the serving network node 110 may configure the UE 120 to perform active performance monitoring or inactive performance monitoring, and may decide whether to enable legacy measurement reporting or disable legacy measurement reporting such that handovers are performed exclusively according to measurement events that are predicted using the predictive model.

In some aspects, as described herein, the performance monitoring reports may generally indicate one or more KPIs for predicted measurement events, measurement event prediction types, and/or null handover event predictions. In some aspects, the performance monitoring reports may indicate that one or more inferencing configurations or the predictive model are performing poorly based on the KPIs that are computed during performance monitoring. In such examples, the performance monitoring report may include a cause indicating a performance issue with the predictive model, and may optionally include or omit the KPIs that indicate the poor performance for the predictive model.

In some aspects, in addition to one or more KPIs, the one or more performance monitoring reports may indicate ground truth information for one or more predicted measurement events (e.g., whether an actual measurement event, based on actual serving cell and neighbor cell measurements, occurred within the ETD of a corresponding predicted measurement event). In some cases, such as when a handover is executed or attempted for predicted A1-A2 and A4 measurement events, the UE 120 may have the ability to obtain the ground truth information for the predicted measurement events when the handover procedure is initiated (e.g., because the predicted measurement events are based solely on a serving cell measurement or a neighbor cell measurement).

However, when a handover is executed or attempted for predicted A3 or A5 measurement events, which are based on a serving cell measurement and a neighbor cell measurement, the UE 120 may or may not have the ability to obtain the ground truth information for the predicted measurement event when the handover procedure is initiated. For example, the UE 120 may obtain the ground truth information in cases where the actual measurement event does occur before the UE 120 initiates the handover to the target cell (e.g., because the serving cell and neighbor cell measurements are both available at the time when the handover is initiated). However, the UE 120 may not have the ground truth information in cases where the actual measurement event has not occurred before the UE 120 initiates the handover to the target cell (e.g., because serving cell and neighbor cell measurements may satisfy a condition for the actual measurement event after the handover is initiated).

Accordingly, in such cases, the UE 120 may obtain measurements of the source cell (which is a neighbor cell after the handover) based on a measurement configuration for the source cell. Furthermore, in cases where the UE 120 transmits a predicted measurement event report or a performance monitoring report associated with a predicted A3 or A5 measurement event, the report(s) may be transmitted to the source cell or the target cell (e.g., in a successful handover message, a PSCell report, a radio link failure (RLF) report, or an SCG failure information report), and may contain information that indicates whether the handover to the target cell was a success or a failure if the UE 120 received a handover command, an indication of whether an actual measurement event (A3 or A5) occurred before the UE 120 initiated the handover with the target cell, an indication of whether the actual measurement event occurred within the ETD time around the predicted time of the measurement event occurrence, and/or the target cell and source cell measurements (e.g., RSRP, RSRQ, and/or SINR measurements) after successful handover, which may indicate whether the handover decision was correct. Alternatively, the predicted event and/or performance monitoring report may be transmitted on the source and/or the target cell (e.g., in a successful handover message, a PSCell report, an RLF report, or an SCG failure information report) after the UE 120 collects and stores the KPIs over a configured duration of time and/or over multiple handover events, which reduces the reporting overhead. In such examples, the serving network node 110 may configure the UE 120 with the duration or periodicity after which the UE 120 transmits such report(s), and the reporting can be based on configured thresholds on the KPIs (e.g., the report is transmitted if a KPI has a value that satisfies or fails to satisfy a threshold). In some aspects, the report(s) in such cases may contain information indicating a fraction or proportion of handover attempts due to measurement event prediction, among all handover attempts, a handover success rate, and/or a handover failure rate. Furthermore, if the predicted event or performance monitoring report is received on a target cell by a target network node 110, the target network node 110 may forward the report to the source network node 110 over the Xn interface, and the forwarded report may include an identity and/or context information associated with the UE 120.

Alternatively, as shown by reference number 745 in FIG. 7B, the UE 120 may transmit event-triggered measurement reports and/or event prediction reports to the serving network node 110 when network-side performance monitoring is configured. In such cases, as shown by reference number 750 in FIG. 7B, the serving network node 110 may compute the performance monitoring KPIs for the predictive model that the UE 120 uses to predict measurement events. For example, for network-side monitoring, the serving network node 110 may use the event-triggered measurement reports transmitted by the UE 120 to obtain ground truth information for measurement events that are predicted by the UE 120. The UE 120 generally provides the measurement event prediction reports according to an inferencing configuration provided by the serving network node 110, and the measurement event prediction reports may indicate information such as whether the measurement event prediction report is for direct or indirect measurement event prediction, an expected time when a predicted measurement event will occur and/or a probability that the actual measurement event will within an indicated time window around the expected time, and/or cell and/or beam measurements and measurement predictions for one or more serving cells and/or neighbor cells for a configured prediction window, among other examples. In some aspects, the UE 120 may additionally provide per predicted measurement event performance monitoring reports, as discussed in further detail above, where the performance monitoring reports for each predicted measurement event may be useful for the serving network node 110 to obtain ground truth information for a predicted measurement event when an actual measurement event did not occur before the UE 120 initiated a handover.

As shown by reference number 755 in FIG. 7A for UE-assisted performance monitoring and in FIG. 7B for network-side performance monitoring, the serving network node 110 may transmit, and the UE 120 may receive, an LCM request for performing one or more LCM operations for the predictive model. For example, in some aspects, the LCM request may deactivate or disable the UE-side predictive model, or reconfigure the predictive model or the inferencing configuration of the UE 120, which may result in the UE 120 switching to a different predictive model. For example, if the KPIs reported by the UE 120 or computed by the serving network node 110 indicate poor performance, the LCM request can request deactivation of the UE-side predictive model, and UE 120 can fall back to using regular measurement event reporting based on actual measurements. Additionally, or alternatively, if the KPIs reported by the UE 120 or computed by the serving network node 110 indicate poor performance for certain measurement events, or for certain serving cells or neighbor cells, the LCM request can include a request to modify the configuration for the UE 120 (e.g., disabling the measurement events or some serving cells and/or neighbor cells, which might result in the UE 120 using a different predictive model). Additionally, or alternatively, if the KPIs reported by the UE 120 or computed by the serving network node 110 indicate good performance, the LCM request may include a request to disable performance monitoring and/or disable legacy measurement event reporting.

In some aspects, as shown by reference number 760 in FIG. 7A and 7B, the UE 120 may execute one or more LCM operations for the predictive model. For example, in some aspects, the one or more LCM operations may be indicated in the LCM request and/or configuration information received from the serving network node 110 for UE-assisted or network-side performance monitoring. Alternatively, for UE-side performance monitoring, the UE 120 may select the LCM operations to perform based on the locally computed KPIs. As shown by reference number 765 in FIG. 7A and 7B, the UE 120 may then transmit, and the serving network node 110 may receive, information about the LCM operation(s) executed by the UE 120 (e.g., indicating which LCM operations were executed, such as activating or deactivating the predictive model, switching to a different predictive model, or falling back to a legacy non-inferencing mode).

FIG. 8 is a diagram illustrating an example process 800 performed, for example, at a UE or an apparatus of a UE. Example process 800 is an example where the apparatus or the UE (e.g., UE 120) performs operations associated with performance monitoring for measurement event prediction.

As shown in FIG. 8, in some aspects, process 800 may include wirelessly receiving, from a network node, a performance monitoring configuration (block 810). For example, the UE (e.g., using reception component 1002 or communication manager 1006, depicted in FIG. 10) may wirelessly receive, from a network node, a performance monitoring configuration, as described above.

As further shown in FIG. 8, in some aspects, process 800 may include obtaining, using a predictive model, one or more predicted measurement events associated with one or more of a serving cell or a neighbor cell (block 820). For example, the UE (e.g., using reception component 1002 or communication manager 1006, depicted in FIG. 10) may obtain, using a predictive model, one or more predicted measurement events associated with one or more of a serving cell or a neighbor cell, as described above.

As further shown in FIG. 8, in some aspects, process 800 may include wirelessly transmitting, to the network node, one or more reports that includes one or more KPIs associated with the one or more predicted measurement events in accordance with the performance monitoring configuration (block 830). For example, the UE (e.g., using transmission component 1004 or communication manager 1006, depicted in FIG. 10) may wirelessly transmit, to the network node, one or more reports that includes one or more KPIs associated with the one or more predicted measurement events in accordance with the performance monitoring configuration, as described above.

Process 800 may include additional aspects, such as any single aspect or any combination of aspects described below or in connection with one or more other processes described elsewhere herein.

In a first aspect, the performance monitoring configuration is associated with one or more measurement event types.

In a second aspect, alone or in combination with the first aspect, the performance monitoring configuration indicates whether the UE or the network node computes the one or more KPIs and whether the UE or the network node initiates one or more LCM operations for the predictive model in accordance with the one or more KPIs.

In a third aspect, alone or in combination with one or more of the first and second aspects, the performance monitoring configuration indicates whether to obtain the one or more predicted measurement events in accordance with actual measurements or predicted measurements.

In a fourth aspect, alone or in combination with one or more of the first through third aspects, the performance monitoring configuration is associated with an inferencing configuration for the predictive model.

In a fifth aspect, alone or in combination with one or more of the first through fourth aspects, the performance monitoring configuration indicates an event time difference for evaluating whether a ground truth measurement event associated with a predicted measurement event has occurred.

In a sixth aspect, alone or in combination with one or more of the first through fifth aspects, the performance monitoring configuration indicates whether the one or more reports are to indicate whether a ground truth measurement event associated with a predicted measurement event occurred before or after the predicted measurement event.

In a seventh aspect, alone or in combination with one or more of the first through sixth aspects, the performance monitoring configuration indicates content to include in the one or more reports.

In an eighth aspect, alone or in combination with one or more of the first through seventh aspects, the performance monitoring configuration indicates one or more parameters for obtaining one or more of actual measurements or predicted measurements for one or more of the serving cell or the neighbor cell.

In a ninth aspect, alone or in combination with one or more of the first through eighth aspects, process 800 includes wirelessly transmitting, to the network node, a request to configure performance monitoring for one or more performance monitoring scenarios, wherein the performance monitoring configuration is responsive to the request.

In a tenth aspect, alone or in combination with one or more of the first through ninth aspects, the one or more reports include one report per predicted measurement event.

In an eleventh aspect, alone or in combination with one or more of the first through tenth aspects, process 800 includes wirelessly receiving a handover command associated with a handover from a source cell to a target cell in accordance with the one or more predicted measurement events, and obtaining one or more actual measurements associated with the source cell and the target cell that indicate ground truth information for the one or more predicted measurement events, wherein the one or more reports indicate the ground truth information for the one or more predicted measurement events.

In a twelfth aspect, alone or in combination with one or more of the first through eleventh aspects, the one or more reports that indicate the ground truth information include one or more of an indication of whether the handover was successful, an indication of whether the one or more actual measurements associated with the source cell and the target cell satisfied one or more conditions associated with one or more actual measurement events, corresponding to the one or more predicted measurement events, before the handover command was executed, an indication of whether a difference between a first time when the one or more predicted measurement events were predicted to occur and a second time when the one or more actual measurement events satisfied the one or more conditions associated with the one or more actual measurement events satisfies a threshold, or the one or more actual measurements associated with the source cell and the target cell that indicate the ground truth information.

In a thirteenth aspect, alone or in combination with one or more of the first through twelfth aspects, the one or more reports that indicate the ground truth information are transmitted in accordance with a periodicity indicated by the performance monitoring configuration or the one or more KPIs satisfying one or more thresholds indicated by the performance monitoring configuration.

In a fourteenth aspect, alone or in combination with one or more of the first through thirteenth aspects, the one or more reports indicate one or more of a proportion of attempted handovers that are associated with predicted measurement events, a handover success rate, or a handover failure rate.

In a fifteenth aspect, alone or in combination with one or more of the first through fourteenth aspects, the one or more reports are included in a message indicating that the handover was successful, a PSCell report, an RLF report, or an SCG failure report.

In a sixteenth aspect, alone or in combination with one or more of the first through fifteenth aspects, the one or more KPIs include one or more of one or more counter values for one or more of correct predicted measurement events, incorrect predicted measurement events, missed predicted measurement events, or null predicted measurement events, or one or more performance metrics that are derived from counter values for one or more of correct predicted measurement events, incorrect predicted measurement events, missed predicted measurement events, or null predicted measurement events.

In a seventeenth aspect, alone or in combination with one or more of the first through sixteenth aspects, the one or more KPIs include one or more of one or more KPIs for predicted measurement events associated with one or more serving cells, one or more KPIs for predicted measurement events associated with one or more serving cell and neighbor cell pairs, one or more KPIs for predicted measurement events associated with one or more neighbor cells, or one or more KPIs for predicted measurement events associated with one or more secondary cell and neighbor cell pairs.

In an eighteenth aspect, alone or in combination with one or more of the first through seventeenth aspects, the one or more reports include a functionality identifier or a logical model identifier associated with the one or more KPIs.

In a nineteenth aspect, alone or in combination with one or more of the first through eighteenth aspects, the one or more KPIs include one or more of an average measurement difference between a serving primary cell and a neighbor cell with a best measurement, an average measurement at source cells and target cells before and after one or more handovers, or a time difference or average time difference between a time when measurements of a source cell and a target cell are equal and an actual handover time.

In a twentieth aspect, alone or in combination with one or more of the first through nineteenth aspects, process 800 includes wirelessly receiving, from the network node, information that disables measurement reporting associated with actual measurement events in accordance with the one or more reports associated with the one or more predicted measurement events.

In a twenty-first aspect, alone or in combination with one or more of the first through twentieth aspects, the performance monitoring configuration indicates a periodicity for transmitting the one or more reports.

In a twenty-second aspect, alone or in combination with one or more of the first through twenty-first aspects, the performance monitoring configuration indicates one or more triggering conditions for transmitting the one or more reports.

In a twenty-third aspect, alone or in combination with one or more of the first through twenty-second aspects, the performance monitoring configuration indicates one or more conditions for not transmitting the one or more reports.

In a twenty-fourth aspect, alone or in combination with one or more of the first through twenty-third aspects, process 800 includes wirelessly receiving, from the network node, a request for the one or more reports, wherein the one or more reports are transmitted responsive to the request.

In a twenty-fifth aspect, alone or in combination with one or more of the first through twenty-fourth aspects, the one or more reports include an indication of a performance issue for the predictive model in accordance with the one or more KPIs failing to satisfy one or more performance criteria.

In a twenty-sixth aspect, alone or in combination with one or more of the first through twenty-fifth aspects, process 800 includes wirelessly receiving, from the network node, one or more LCM requests associated with the predictive model in accordance with the one or more reports, and performing one or more LCM operations for the predictive model in accordance with the one or more LCM requests.

In a twenty-seventh aspect, alone or in combination with one or more of the first through twenty-sixth aspects, the one or more LCM requests include a request to deactivate the predictive model.

In a twenty-eighth aspect, alone or in combination with one or more of the first through twenty-seventh aspects, the one or more LCM requests include a request to modify a configuration of the predictive model.

In a twenty-ninth aspect, alone or in combination with one or more of the first through twenty-eighth aspects, the one or more LCM requests include a request to disable the performance monitoring configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with performance monitoring for measurement event prediction.

As shown in FIG. 9, in some aspects, process 900 may include wirelessly transmitting, to a UE, a performance monitoring configuration (block 910). For example, the network node (e.g., using transmission component 1104 or communication manager 1106, depicted in FIG. 11) may wirelessly transmit, to a UE, a performance monitoring configuration, as described above.

As further shown in FIG. 9, in some aspects, process 900 may include wirelessly receiving, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell (block 920). For example, the network node (e.g., using reception component 1102 or communication manager 1106, depicted in FIG. 11) may wirelessly receive, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell, as described above.

Process 900 may include additional aspects, such as any single aspect or any combination of aspects described below or in connection with one or more other processes described elsewhere herein.

In a first aspect, the performance monitoring configuration is associated with one or more measurement event types.

In a second aspect, alone or in combination with the first aspect, the performance monitoring configuration indicates whether the UE or the network node computes the one or more KPIs and whether the UE or the network node initiates one or more LCM operations for the predictive model in accordance with the one or more KPIs.

In a third aspect, alone or in combination with one or more of the first and second aspects, the performance monitoring configuration indicates whether to obtain the one or more predicted measurement events in accordance with actual measurements or predicted measurements.

In a fourth aspect, alone or in combination with one or more of the first through third aspects, the performance monitoring configuration is associated with an inferencing configuration for the predictive model.

In a fifth aspect, alone or in combination with one or more of the first through fourth aspects, the performance monitoring configuration indicates an event time difference for evaluating whether a ground truth measurement event associated with a predicted measurement event has occurred.

In a sixth aspect, alone or in combination with one or more of the first through fifth aspects, the performance monitoring configuration indicates whether the one or more reports are to indicate whether a ground truth measurement event associated with a predicted measurement event occurred before or after the predicted measurement event.

In a seventh aspect, alone or in combination with one or more of the first through sixth aspects, the performance monitoring configuration indicates content to include in the one or more reports.

In an eighth aspect, alone or in combination with one or more of the first through seventh aspects, the performance monitoring configuration indicates one or more parameters for obtaining one or more of actual measurements or predicted measurements for one or more of the serving cell or the neighbor cell.

In a ninth aspect, alone or in combination with one or more of the first through eighth aspects, process 900 includes wirelessly receiving, from the UE, a request to configure performance monitoring for one or more performance monitoring scenarios, wherein the performance monitoring configuration is responsive to the request.

In a tenth aspect, alone or in combination with one or more of the first through ninth aspects, the one or more reports include one report per predicted measurement event.

In an eleventh aspect, alone or in combination with one or more of the first through tenth aspects, process 900 includes wirelessly transmitting, to the UE, a handover command associated with a handover from a source cell to a target cell in accordance with the one or more predicted measurement events, wherein the one or more reports indicate ground truth information for the one or more predicted measurement events in accordance with one or more actual measurements associated with the source cell and the target cell.

In a twelfth aspect, alone or in combination with one or more of the first through eleventh aspects, the one or more reports that indicate the ground truth information include one or more of an indication of whether the handover was successful, an indication of whether the one or more actual measurements associated with the source cell and the target cell satisfied one or more conditions associated with one or more actual measurement events, corresponding to the one or more predicted measurement events, before the handover command was executed, an indication of whether a difference between a first time when the one or more predicted measurement events were predicted to occur and a second time when the one or more actual measurement events satisfied the one or more conditions associated with the one or more actual measurement events satisfies a threshold, or the one or more actual measurements associated with the source cell and the target cell that indicate the ground truth information.

In a thirteenth aspect, alone or in combination with one or more of the first through twelfth aspects, the one or more reports that indicate the ground truth information are transmitted in accordance with a periodicity indicated by the performance monitoring configuration or the one or more KPIs satisfying one or more thresholds indicated by the performance monitoring configuration.

In a fourteenth aspect, alone or in combination with one or more of the first through thirteenth aspects, the one or more reports indicate one or more of a proportion of attempted handovers that are associated with predicted measurement events, a handover success rate, or a handover failure rate.

In a fifteenth aspect, alone or in combination with one or more of the first through fourteenth aspects, the one or more reports are included in a message indicating that the handover was successful, a PSCell report, an RLF report, or an SCG failure report.

In a sixteenth aspect, alone or in combination with one or more of the first through fifteenth aspects, the one or more KPIs include one or more of one or more counter values for one or more of correct predicted measurement events, incorrect predicted measurement events, missed predicted measurement events, or null predicted measurement events, or one or more performance metrics that are derived from counter values for one or more of correct predicted measurement events, incorrect predicted measurement events, missed predicted measurement events, or null predicted measurement events.

In a seventeenth aspect, alone or in combination with one or more of the first through sixteenth aspects, the one or more KPIs include one or more of one or more KPIs for predicted measurement events associated with one or more serving cells, one or more KPIs for predicted measurement events associated with one or more serving cell and neighbor cell pairs, one or more KPIs for predicted measurement events associated with one or more neighbor cells, or one or more KPIs for predicted measurement events associated with one or more secondary cell and neighbor cell pairs.

In an eighteenth aspect, alone or in combination with one or more of the first through seventeenth aspects, the one or more reports include a functionality identifier or a logical model identifier associated with the one or more KPIs.

In a nineteenth aspect, alone or in combination with one or more of the first through eighteenth aspects, the one or more KPIs include one or more of an average measurement difference between a serving primary cell and a neighbor cell with a best measurement, an average measurement at source cells and target cells before and after one or more handovers, or a time difference or average time difference between a time when measurements of a source cell and a target cell are equal and an actual handover time.

In a twentieth aspect, alone or in combination with one or more of the first through nineteenth aspects, process 900 includes wirelessly transmitting, to the UE, information that disables measurement reporting associated with actual measurement events in accordance with the one or more reports associated with the one or more predicted measurement events.

In a twenty-first aspect, alone or in combination with one or more of the first through twentieth aspects, the performance monitoring configuration indicates a periodicity for transmitting the one or more reports.

In a twenty-second aspect, alone or in combination with one or more of the first through twenty-first aspects, the performance monitoring configuration indicates one or more triggering conditions for transmitting the one or more reports.

In a twenty-third aspect, alone or in combination with one or more of the first through twenty-second aspects, the performance monitoring configuration indicates one or more conditions for not transmitting the one or more reports.

In a twenty-fourth aspect, alone or in combination with one or more of the first through twenty-third aspects, process 900 includes wirelessly transmitting, to the UE, a request for the one or more reports, wherein the one or more reports are transmitted responsive to the request.

In a twenty-fifth aspect, alone or in combination with one or more of the first through twenty-fourth aspects, the one or more reports include an indication of a performance issue for the predictive model in accordance with the one or more KPIs failing to satisfy one or more performance criteria.

In a twenty-sixth aspect, alone or in combination with one or more of the first through twenty-fifth aspects, process 900 includes wirelessly transmitting, to the UE, one or more LCM requests associated with the predictive model in accordance with the one or more reports, wherein the one or more LCM requests indicate one or more LCM operations for the predictive model.

In a twenty-seventh aspect, alone or in combination with one or more of the first through twenty-sixth aspects, the one or more LCM requests include a request to deactivate the predictive model.

In a twenty-eighth aspect, alone or in combination with one or more of the first through twenty-seventh aspects, the one or more LCM requests include a request to modify a configuration of the predictive model.

In a twenty-ninth aspect, alone or in combination with one or more of the first through twenty-eighth aspects, the one or more LCM requests include a request to disable the performance monitoring configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE 120, or a UE 120 may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE 120.

In some aspects, the apparatus 1000 may be configured to perform one or more operations described herein in connection with FIGS. 7A-7B. Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE 120 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE 120 described above in connection with FIG. 1, such as a radio, one or more RF chains, one or more transceivers, or one or more modems, each of which may in turn be coupled with one or more antennas of the UE 120.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

In some aspects, the reception component 1002 may wirelessly receive, from a network node, a performance monitoring configuration. The communication manager 1006 may obtain, using a predictive model, one or more predicted measurement events associated with one or more of a serving cell or a neighbor cell. The transmission component 1004 may wirelessly transmit, to the network node, one or more reports that includes one or more KPIs associated with the one or more predicted measurement events in accordance with the performance monitoring configuration. Additionally, or alternatively, the communication manager 150 may perform one or more other operations described herein.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node 110, or a network node 110 may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node 110.

In some aspects, the apparatus 1100 may be configured to perform one or more operations described herein in connection with FIGS. 7A-7B. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network node 110 described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

In some aspects, the transmission component 1104 may wirelessly transmit, to a UE, a performance monitoring configuration. The reception component 1102 may wirelessly receive, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell. Additionally, or alternatively, the communication manager 155 may perform one or more other operations described herein.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: wirelessly receiving, from a network node, a performance monitoring configuration; obtaining, using a predictive model, one or more predicted measurement events associated with one or more of a serving cell or a neighbor cell; and wirelessly transmitting, to the network node, one or more reports that includes one or more KPIs associated with the one or more predicted measurement events in accordance with the performance monitoring configuration.

Aspect 2: The method of Aspect 1, wherein the performance monitoring configuration is associated with one or more measurement event types.

Aspect 3: The method of any of Aspects 1-2, wherein the performance monitoring configuration indicates whether the UE or the network node computes the one or more KPIs and whether the UE or the network node initiates one or more LCM operations for the predictive model in accordance with the one or more KPIs.

Aspect 4: The method of any of Aspects 1-3, wherein the performance monitoring configuration indicates whether to obtain the one or more predicted measurement events in accordance with actual measurements or predicted measurements.

Aspect 5: The method of any of Aspects 1-4, wherein the performance monitoring configuration is associated with an inferencing configuration for the predictive model.

Aspect 6: The method of any of Aspects 1-5, wherein the performance monitoring configuration indicates an event time difference for evaluating whether a ground truth measurement event associated with a predicted measurement event has occurred.

Aspect 7: The method of any of Aspects 1-6, wherein the performance monitoring configuration indicates whether the one or more reports are to indicate whether a ground truth measurement event associated with a predicted measurement event occurred before or after the predicted measurement event.

Aspect 8: The method of any of Aspects 1-7, wherein the performance monitoring configuration indicates content to include in the one or more reports.

Aspect 9: The method of any of Aspects 1-8, wherein the performance monitoring configuration indicates one or more parameters for obtaining one or more of actual measurements or predicted measurements for one or more of the serving cell or the neighbor cell.

Aspect 10: The method of any of Aspects 1-9, further comprising: wirelessly transmitting, to the network node, a request to configure performance monitoring for one or more performance monitoring scenarios, wherein the performance monitoring configuration is responsive to the request.

Aspect 11: The method of any of Aspects 1-10, wherein the one or more reports include one report per predicted measurement event.

Aspect 12: The method of any of Aspects 1-11, further comprising: wirelessly receiving a handover command associated with a handover from a source cell to a target cell in accordance with the one or more predicted measurement events; and obtaining one or more actual measurements associated with the source cell and the target cell that indicate ground truth information for the one or more predicted measurement events, wherein the one or more reports indicate the ground truth information for the one or more predicted measurement events.

Aspect 13: The method of Aspect 12, wherein the one or more reports that indicate the ground truth information include one or more of: an indication of whether the handover was successful, an indication of whether the one or more actual measurements associated with the source cell and the target cell satisfied one or more conditions associated with one or more actual measurement events, corresponding to the one or more predicted measurement events, before the handover command was executed, an indication of whether a difference between a first time when the one or more predicted measurement events were predicted to occur and a second time when the one or more actual measurement events satisfied the one or more conditions associated with the one or more actual measurement events satisfies a threshold, or the one or more actual measurements associated with the source cell and the target cell that indicate the ground truth information.

Aspect 14: The method of Aspect 12, wherein the one or more reports that indicate the ground truth information are transmitted in accordance with a periodicity indicated by the performance monitoring configuration or the one or more KPIs satisfying one or more thresholds indicated by the performance monitoring configuration.

Aspect 15: The method of Aspect 12, wherein the one or more reports indicate one or more of a proportion of attempted handovers that are associated with predicted measurement events, a handover success rate, or a handover failure rate.

Aspect 16: The method of Aspect 12, wherein the one or more reports are included in a message indicating that the handover was successful, a PSCell report, an RLF report, or an SCG failure report.

Aspect 17: The method of any of Aspects 1-16, wherein the one or more KPIs include one or more of: one or more counter values for one or more of correct predicted measurement events, incorrect predicted measurement events, missed predicted measurement events, or null predicted measurement events, or one or more performance metrics that are derived from counter values for one or more of correct predicted measurement events, incorrect predicted measurement events, missed predicted measurement events, or null predicted measurement events.

Aspect 18: The method of any of Aspects 1-17, wherein the one or more KPIs include one or more of: one or more KPIs for predicted measurement events associated with one or more serving cells, one or more KPIs for predicted measurement events associated with one or more serving cell and neighbor cell pairs, one or more KPIs for predicted measurement events associated with one or more neighbor cells, or one or more KPIs for predicted measurement events associated with one or more secondary cell and neighbor cell pairs.

Aspect 19: The method of any of Aspects 1-18, wherein the one or more reports include a functionality identifier or a logical model identifier associated with the one or more KPIs.

Aspect 20: The method of any of Aspects 1-19, wherein the one or more KPIs include one or more of: an average measurement difference between a serving primary cell and a neighbor cell with a best measurement, an average measurement at source cells and target cells before and after one or more handovers, or a time difference or average time difference between a time when measurements of a source cell and a target cell are equal and an actual handover time.

Aspect 21: The method of any of Aspects 1-20, further comprising: wirelessly receiving, from the network node, information that disables measurement reporting associated with actual measurement events in accordance with the one or more reports associated with the one or more predicted measurement events.

Aspect 22: The method of any of Aspects 1-21, wherein the performance monitoring configuration indicates a periodicity for transmitting the one or more reports.

Aspect 23: The method of any of Aspects 1-22, wherein the performance monitoring configuration indicates one or more triggering conditions for transmitting the one or more reports.

Aspect 24: The method of any of Aspects 1-23, wherein the performance monitoring configuration indicates one or more conditions for not transmitting the one or more reports.

Aspect 25: The method of any of Aspects 1-24, further comprising: wirelessly receiving, from the network node, a request for the one or more reports, wherein the one or more reports are transmitted responsive to the request.

Aspect 26: The method of any of Aspects 1-25, wherein the one or more reports include an indication of a performance issue for the predictive model in accordance with the one or more KPIs failing to satisfy one or more performance criteria.

Aspect 27: The method of any of Aspects 1-26, further comprising: wirelessly receiving, from the network node, one or more LCM requests associated with the predictive model in accordance with the one or more reports; and performing one or more LCM operations for the predictive model in accordance with the one or more LCM requests.

Aspect 28: The method of Aspect 27, wherein the one or more LCM requests include a request to deactivate the predictive model.

Aspect 29: The method of Aspect 27, wherein the one or more LCM requests include a request to modify a configuration of the predictive model.

Aspect 30: The method of Aspect 27, wherein the one or more LCM requests include a request to disable the performance monitoring configuration.

Aspect 31: A method of wireless communication performed by a network node, comprising: wirelessly transmitting, to a UE, a performance monitoring configuration; and wirelessly receiving, from the UE in accordance with the performance monitoring configuration, one or more reports that includes one or more KPIs associated with one or more predicted measurement events associated with a predictive model, wherein the one or more predicted measurement events are associated with one or more of a serving cell or a neighbor cell.

Aspect 32: The method of Aspect 31, wherein the performance monitoring configuration is associated with one or more measurement event types.

Aspect 33: The method of any of Aspects 31-32, wherein the performance monitoring configuration indicates whether the UE or the network node computes the one or more KPIs and whether the UE or the network node initiates one or more LCM operations for the predictive model in accordance with the one or more KPIs.

Aspect 34: The method of any of Aspects 31-33, wherein the performance monitoring configuration indicates whether to obtain the one or more predicted measurement events in accordance with actual measurements or predicted measurements.

Aspect 35: The method of any of Aspects 31-34, wherein the performance monitoring configuration is associated with an inferencing configuration for the predictive model.

Aspect 36: The method of any of Aspects 31-35, wherein the performance monitoring configuration indicates an event time difference for evaluating whether a ground truth measurement event associated with a predicted measurement event has occurred.

Aspect 37: The method of any of Aspects 31-36, wherein the performance monitoring configuration indicates whether the one or more reports are to indicate whether a ground truth measurement event associated with a predicted measurement event occurred before or after the predicted measurement event.

Aspect 38: The method of any of Aspects 31-37, wherein the performance monitoring configuration indicates content to include in the one or more reports.

Aspect 39: The method of any of Aspects 31-38, wherein the performance monitoring configuration indicates one or more parameters for obtaining one or more of actual measurements or predicted measurements for one or more of the serving cell or the neighbor cell.

Aspect 40: The method of any of Aspects 31-39, further comprising: wirelessly receiving, from the UE, a request to configure performance monitoring for one or more performance monitoring scenarios, wherein the performance monitoring configuration is responsive to the request.

Aspect 41: The method of any of Aspects 31-40, wherein the one or more reports include one report per predicted measurement event.

Aspect 42: The method of any of Aspects 31-41, further comprising: wirelessly transmitting, to the UE, a handover command associated with a handover from a source cell to a target cell in accordance with the one or more predicted measurement events, wherein the one or more reports indicate ground truth information for the one or more predicted measurement events in accordance with one or more actual measurements associated with the source cell and the target cell.

Aspect 43: The method of Aspect 42, wherein the one or more reports that indicate the ground truth information include one or more of: an indication of whether the handover was successful, an indication of whether the one or more actual measurements associated with the source cell and the target cell satisfied one or more conditions associated with one or more actual measurement events, corresponding to the one or more predicted measurement events, before the handover command was executed, an indication of whether a difference between a first time when the one or more predicted measurement events were predicted to occur and a second time when the one or more actual measurement events satisfied the one or more conditions associated with the one or more actual measurement events satisfies a threshold, or the one or more actual measurements associated with the source cell and the target cell that indicate the ground truth information.

Aspect 44: The method of Aspect 42, wherein the one or more reports that indicate the ground truth information are transmitted in accordance with a periodicity indicated by the performance monitoring configuration or the one or more KPIs satisfying one or more thresholds indicated by the performance monitoring configuration.

Aspect 45: The method of Aspect 42, wherein the one or more reports indicate one or more of a proportion of attempted handovers that are associated with predicted measurement events, a handover success rate, or a handover failure rate.

Aspect 46: The method of Aspect 42, wherein the one or more reports are included in a message indicating that the handover was successful, a PSCell report, an RLF report, or an SCG failure report.

Aspect 47: The method of any of Aspects 31-46, wherein the one or more KPIs include one or more of: one or more counter values for one or more of correct predicted measurement events, incorrect predicted measurement events, missed predicted measurement events, or null predicted measurement events, or one or more performance metrics that are derived from counter values for one or more of correct predicted measurement events, incorrect predicted measurement events, missed predicted measurement events, or null predicted measurement events.

Aspect 48: The method of any of Aspects 31-47, wherein the one or more KPIs include one or more of: one or more KPIs for predicted measurement events associated with one or more serving cells, one or more KPIs for predicted measurement events associated with one or more serving cell and neighbor cell pairs, one or more KPIs for predicted measurement events associated with one or more neighbor cells, or one or more KPIs for predicted measurement events associated with one or more secondary cell and neighbor cell pairs.

Aspect 49: The method of any of Aspects 31-48, wherein the one or more reports include a functionality identifier or a logical model identifier associated with the one or more KPIs.

Aspect 50: The method of any of Aspects 31-49, wherein the one or more KPIs include one or more of: an average measurement difference between a serving primary cell and a neighbor cell with a best measurement, an average measurement at source cells and target cells before and after one or more handovers, or a time difference or average time difference between a time when measurements of a source cell and a target cell are equal and an actual handover time.

Aspect 51: The method of any of Aspects 31-50, further comprising: wirelessly transmitting, to the UE, information that disables measurement reporting associated with actual measurement events in accordance with the one or more reports associated with the one or more predicted measurement events.

Aspect 52: The method of any of Aspects 31-51, wherein the performance monitoring configuration indicates a periodicity for transmitting the one or more reports.

Aspect 53: The method of any of Aspects 31-52, wherein the performance monitoring configuration indicates one or more triggering conditions for transmitting the one or more reports.

Aspect 54: The method of any of Aspects 31-53, wherein the performance monitoring configuration indicates one or more conditions for not transmitting the one or more reports.

Aspect 55: The method of any of Aspects 31-54, further comprising: wirelessly transmitting, to the UE, a request for the one or more reports, wherein the one or more reports are transmitted responsive to the request.

Aspect 56: The method of any of Aspects 31-55, wherein the one or more reports include an indication of a performance issue for the predictive model in accordance with the one or more KPIs failing to satisfy one or more performance criteria.

Aspect 57: The method of any of Aspects 31-56, further comprising: wirelessly transmitting, to the UE, one or more LCM requests associated with the predictive model in accordance with the one or more reports, wherein the one or more LCM requests indicate one or more LCM operations for the predictive model.

Aspect 58: The method of Aspect 57, wherein the one or more LCM requests include a request to deactivate the predictive model.

Aspect 59: The method of Aspect 57, wherein the one or more LCM requests include a request to modify a configuration of the predictive model.

Aspect 60: The method of Aspect 57, wherein the one or more LCM requests include a request to disable the performance monitoring configuration.

Aspect 61: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-60.

Aspect 62: An apparatus for wireless communication at a device, the apparatus comprising one or more memories and one or more processors coupled to the one or more memories, the one or more processors configured to cause the device to perform the method of one or more of Aspects 1-60.

Aspect 63: An apparatus for wireless communication, the apparatus comprising at least one means for performing the method of one or more of Aspects 1-60.

Aspect 64: A non-transitory computer-readable medium storing code for wireless communication, the code comprising instructions executable by one or more processors to perform the method of one or more of Aspects 1-60.

Aspect 65: A non-transitory computer-readable medium storing a set of instructions for wireless communication, the set of instructions comprising one or more instructions that, when executed by one or more processors of a device, cause the device to perform the method of one or more of Aspects 1-60.

Aspect 66: A device for wireless communication, the device comprising a processing system that includes one or more processors and one or more memories coupled with the one or more processors, the processing system configured to cause the device to perform the method of one or more of Aspects 1-60.

Aspect 67: An apparatus for wireless communication at a device, the apparatus comprising one or more memories and one or more processors coupled to the one or more memories, the one or more processors individually or collectively configured to cause the device to perform the method of one or more of Aspects 1-60.

Aspect 68: A device comprising a processing system that includes one or more processors and one or more code-storing memories coupled with the one or more processors, the processing system configured to cause the device to perform the method of one or more of Aspects 1-60.

Aspect 69: A device comprising a processing system that includes processor circuitry and code-storing memory circuitry, the processing system configured to cause the device to perform the method of one or more of Aspects 1-60.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more antennas; and
a processing system that includes processor circuitry and memory circuitry that store code, the processing system configured to cause the UE to:
wirelessly receive, from a network node, a performance monitoring configuration;
obtain, using a predictive model, one or more predicted measurement events associated with one or more of a serving cell or a neighbor cell; and
wirelessly transmit, to the network node, one or more reports that includes one or more key performance indicators (KPIs) associated with the one or more predicted measurement events in accordance with the performance monitoring configuration.

2. The UE of claim 1, wherein the performance monitoring configuration is associated with one or more measurement event types.

3. The UE of claim 1, wherein the performance monitoring configuration indicates whether the UE or the network node computes the one or more KPIs and whether the UE or the network node initiates one or more lifecycle management operations for the predictive model in accordance with the one or more KPIs.

4. The UE of claim 1, wherein the performance monitoring configuration indicates whether to obtain the one or more predicted measurement events in accordance with actual measurements or predicted measurements.

5. The UE of claim 1, wherein the performance monitoring configuration is associated with an inferencing configuration for the predictive model.

6. The UE of claim 1, wherein the performance monitoring configuration indicates an event time difference for evaluating whether a ground truth measurement event associated with a predicted measurement event has occurred.

7. The UE of claim 1, wherein the performance monitoring configuration indicates whether the one or more reports are to indicate whether a ground truth measurement event associated with a predicted measurement event occurred before or after the predicted measurement event.

8. The UE of claim 1, wherein the performance monitoring configuration indicates content to include in the one or more reports.

9. The UE of claim 1, wherein the performance monitoring configuration indicates one or more parameters for obtaining one or more of actual measurements or predicted measurements for one or more of the serving cell or the neighbor cell.

10. The UE of claim 1, wherein the processing system is further configured to cause the UE to:
wirelessly transmit, to the network node, a request to configure performance monitoring for one or more performance monitoring scenarios, wherein the performance monitoring configuration is responsive to the request.

11. The UE of claim 1, wherein the one or more reports include one report per predicted measurement event.

12. The UE of claim 1, wherein the processing system is further configured to cause the UE to:
wirelessly receive a handover command associated with a handover from a source cell to a target cell in accordance with the one or more predicted measurement events; and
obtain one or more actual measurements associated with the source cell and the target cell that indicate ground truth information for the one or more predicted measurement events, wherein the one or more reports indicate the ground truth information for the one or more predicted measurement events.

13. The UE of claim 1, wherein the one or more KPIs include one or more of:
one or more counter values for one or more of correct predicted measurement events, incorrect predicted measurement events, missed predicted measurement events, or null predicted measurement events, or
one or more performance metrics that are derived from counter values for one or more of correct predicted measurement events, incorrect predicted measurement events, missed predicted measurement events, or null predicted measurement events.

14. The UE of claim 1, wherein the one or more KPIs include one or more of:
one or more KPIs for predicted measurement events associated with one or more serving cells,
one or more KPIs for predicted measurement events associated with one or more serving cell and neighbor cell pairs,
one or more KPIs for predicted measurement events associated with one or more neighbor cells,
one or more KPIs for predicted measurement events associated with one or more secondary cell and neighbor cell pairs,
an average measurement difference between a serving primary cell and a neighbor cell with a best measurement,
an average measurement at source cells and target cells before and after one or more handovers, or
a time difference or average time difference between a time when measurements of a source cell and a target cell are equal and an actual handover time.

15. The UE of claim 1, wherein the one or more reports include a functionality identifier or a logical model identifier associated with the one or more KPIs.

16. The UE of claim 1, wherein the processing system is further configured to cause the UE to:
wirelessly receive, from the network node, information that disables measurement reporting associated with actual measurement events in accordance with the one or more reports associated with the one or more predicted measurement events.

17. The UE of claim 1, wherein the performance monitoring configuration indicates one or more of a periodicity for transmitting the one or more reports, one or more triggering conditions for transmitting the one or more reports, or one or more conditions for not transmitting the one or more reports.

18. The UE of claim 1, wherein the processing system is further configured to cause the UE to:
wirelessly receive, from the network node, one or more lifecycle management requests associated with the predictive model in accordance with the one or more reports; and
perform one or more lifecycle management operations for the predictive model in accordance with the one or more lifecycle management requests.

19. A network node, comprising:
one or more antennas; and
a processing system that includes processor circuitry and memory circuitry that store code, the processing system configured to cause the network node to:
wirelessly transmit, to a user equipment (UE), a performance monitoring configuration; and
wirelessly receive, from the UE in accordance with the performance monitoring configuration, one or more reports that includes one or more key performance indicators (KPIs) associated with one or more predicted measurement events associated with a predictive model, wherein the one or more predicted measurement events are associated with one or more of a serving cell or a neighbor cell.

20. A method of wireless communication performed by a user equipment (UE), comprising:
wirelessly receiving, from a network node, a performance monitoring configuration;
obtaining, using a predictive model, one or more predicted measurement events associated with one or more of a serving cell or a neighbor cell; and
wirelessly transmitting, to the network node, one or more reports that includes one or more key performance indicators (KPIs) associated with the one or more predicted measurement events in accordance with the performance monitoring configuration.
